(19) United States
(12) Patent Application Publication
(10) Pub. No.: US 2011/0204042 A1
(43) Pub. Date: Aug. 25, 2011

(54) ELECTROMAGNETIC INDUCTION HEATING UNIT AND AIR CONDITIONING APPARATUS

(75) Inventors: Masahiro Wakashima, Osaka (JP); Junichi Shimoda, Osaka (JP)

(73) Assignee: Daikin Industries, Ltd., Osaka-shi, Osaka (JP)

(21) Appl. No.: 13/119,271

(22) PCT Filed: Sep. 14, 2009
(86) PCT No.: PCT/JP2009/004568

§ 371 Date: Apr. 1, 2011

(30) Foreign Application Priority Data
Sep. 17, 2008 (JP) 2008-238739

(51) Int. Cl. H05B 6/10

(52) U.S. Cl. 219/635

(57) ABSTRACT

An electromagnetic induction heating unit is configured to heat at least one of a refrigerant tube and a member in thermal contact with a refrigerant that flows through the refrigerant tube. The electromagnetic induction heating unit includes a coil and a magnetic member. The coil is disposed in a vicinity of the refrigerant tube. The magnetic member includes a magnetic material. The magnetic member is disposed on at least one of a first side of the coil along a direction in which the refrigerant tube extends, a second side opposite from the first side with respect to the coil, and an outside of the coil that is opposite to an inside of the coil. The inside of the coil is a refrigerant tube side of the coil.

### TECHNICAL FIELD

The present invention relates to an electromagnetic induction heating unit and to an air conditioning apparatus.

### BACKGROUND ART

In a refrigeration cycle, a radiator for releasing the heat of a refrigerant, a heater for imparting heat to the refrigerant, and other components are provided. The refrigerant circulated through the refrigeration cycle obtains heat by heat exchange with indoor air in an air-cooling operation cycle, and obtains heat by heat exchange with outdoor air in an air-warming operation cycle, for example.

According to the refrigeration cycle for an air conditioner as described in Patent Document 1 (Japanese Unexamined Patent Application Publication No. 8-210720), a system is proposed in which heat is obtained not only from indoor air or outdoor air as described above, but the refrigerant obtains heat separately through the use of a refrigerant heating apparatus. In this refrigerant heating apparatus, a heat exchanger through which the refrigerant flows is heated by a burner, and heat is thereby imparted to the refrigerant that flows through the inside of the heat exchanger. Since a refrigerant heating apparatus is thus employed in the air conditioner, the refrigerant can be heated without limitations being imposed by such factors as the indoor or outdoor temperature in cases in which heat is required for the refrigerant.

### SUMMARY OF THE INVENTION

### Problems to be Solved by the Invention

An electromagnetic induction heating system as an electrical system may also be used as a refrigerant heating apparatus such as the one described above, instead of a burner or other heating system which uses fire. For example, by winding an electromagnetic induction coil around a refrigerant tube that includes a magnetic material, and supplying an electric current to the electromagnetic induction heating coil, the resultant magnetic flux causes heat evolution in the refrigerant tube. The heat evolution in the refrigerant tube can be used to heat the refrigerant.

However, when a magnetic field is generated in the case of heating the refrigerant tube by electromagnetic induction, lines of magnetic force occur not only inside the refrigerant tube, but also in other portions.

The present invention was developed in view of the foregoing problems, and an object of the present invention is to provide an electromagnetic induction heating unit and air conditioning apparatus whereby the effect of the magnetic field on portions other than the refrigerant tube can be minimized in a case in which a magnetic field is generated by the electromagnetic induction heating unit to perform electromagnetic induction heating.

### Means for Solving the Problems

An electromagnetic induction heating unit according to a first aspect of the present invention is an electromagnetic induction heating unit for heating at least one of a refrigerant tube and a member which makes thermal contact with a refrigerant that flows through the refrigerant tube; and the electromagnetic induction heating unit comprises a coil and a magnetic member. The coil is disposed in the vicinity of the refrigerant tube. The magnetic member includes a magnetic material. The magnetic member is disposed on at least any one of one side of the coil in the direction in which the refrigerant tube extends, and the other side on the opposite side from the one side with respect to the coil, and in a portion on the outside opposite the inside, the inside being the refrigerant tube side of the coil. The term “refrigerant tube” herein includes the portion constituting the inside surface, the portion constituting the outside surface, and the portion positioned between the inside surface and the outside surface. In other words, a member for generating an eddy current by electromagnetic induction may constitute the external surface of the refrigerant tube or the inside surface of the refrigerant tube, or may be positioned between the external surface and the inside surface of the refrigerant tube. The “member which makes thermal contact with the refrigerant that flows through the refrigerant tube” includes, for example, a member disposed on the refrigerant passage in the tube so as to make direct contact with the refrigerant, a member disposed on the outside of the refrigerant tube, for heating the refrigerant tube, and the like. The “refrigerant tube” and the “member which makes thermal contact with a refrigerant that flows through the refrigerant tube” preferably include or are alloyed with a magnetic substance in at least a portion thereof. From the perspective of achieving efficient heating relative to power consumption, the magnetic substance is preferably a ferromagnetic substance.

In this electromagnetic induction heating unit, when a current is supplied to the coil of the electromagnetic induction heating unit and the refrigerant tube is heated by electromagnetic induction, lines of magnetic force flow to portions other than the refrigerant tube, and a magnetic field is generated. Since the magnetic member which includes a magnetic material are disposed on the outside of the coil, the magnetic field that occurs in portions other than the refrigerant tube actively passes through the magnetic member. Furthermore, by also providing the magnetic member on at least one of any of one side and the other side of the coil in the direction in which the refrigerant tube extends, the magnetic member is disposed closer to the refrigerant tube. The magnetic field that occurs in the portions other than the refrigerant tube can thereby be efficiently made to pass through the magnetic member when electromagnetic induction heating is performed, and it is possible to minimize the degree of leakage to the portions other than the magnetic member in the area outside of the magnetic member.

An electromagnetic induction heating unit according to a second aspect of the present invention is the electromagnetic induction heating unit according to the first aspect of the present invention, wherein the coil is wound around at least a portion of the refrigerant tube.

In this electromagnetic induction heating unit, a portion of the magnetic flux generated by supplying a current to the coil can be directed along the direction in which the refrigerant tube extends. The efficiency of heating by electromagnetic induction can therefore be enhanced in a case in which the longitudinal direction of the magnetic substance included in the refrigerant tube and the axial direction of the refrigerant tube are substantially the same.

An electromagnetic induction heating unit according to a third aspect of the present invention is the electromagnetic induction heating unit according to the first or second aspect of the present invention, wherein the magnetic member has a plurality of magnetic body constituent parts having the same shape and size.

Manufacturing a magnetic body which includes a magnetic material in a desired shape leads to increased manufacturing cost. In the electromagnetic induction heating unit described above, however, the desired shape can be obtained by providing the plurality of magnetic body constituent parts which each have the same shape and size. The magnetic member can thereby be provided inexpensively and in the desired positions.

An electromagnetic induction heating unit according to a fourth aspect of the present invention is the electromagnetic induction heating unit according to any of the first through third aspects of the present invention, comprising at least one magnetic body route in which the magnetic body constituent part disposed on one side of the coil in the direction in which the refrigerant tube extends; the magnetic body constituent part disposed in the portion on the outside opposite the inside, the inside being the refrigerant tube side of the coil; and the magnetic body constituent part disposed on the other side on the opposite side from the one side with respect to the coil are disposed continuously so as to be adjacent to each other. The magnetic body route extends from a portion between the refrigerant tube and the coil in the vicinity of an end part on one side of the coil in the direction in which the refrigerant tube extends, to a portion between the refrigerant tube and the coil in the vicinity of the end part on the other side opposite the one side of the coil, via the outside opposite the inside, the inside being the refrigerant tube side of the coil.

In this electromagnetic induction heating unit, in the magnetic field generated by electromagnetic induction, the magnetic field that occurs in portions other than the refrigerant tube can easily flow along a single selected route formed by the magnetic body constituent parts. The degree of leakage of the magnetic field that leaks from the refrigerant tube to portions other than the magnetic member is therefore further reduced, and the magnetic field can be more efficiently made to pass through the magnetic member.

An electromagnetic induction heating unit according to a fifth aspect of the present invention is the electromagnetic induction heating unit according to any of the first through fourth aspects of the present invention, wherein the magnetic member includes a good conductor material.

In this electromagnetic induction heating unit, even in a case in which lines of magnetic force are made to pass through magnetic force line parts in order to minimize the lines of magnetic force on the outside of the magnetic force line parts, since the magnetic member includes a good conductor material, Joule heat generated by electrical resistance can be minimized.

An electromagnetic induction heating unit according to a sixth aspect of the present invention is the electromagnetic induction heating unit according to any of the first through fifth aspects of the present invention, wherein the magnetic member includes a ferrite.

In this electromagnetic induction heating unit, the lines of magnetic force can be actively made to pass through the magnetic force line parts which include a ferrite, and lines of magnetic force that are further outside than the magnetic force line parts can be minimized.

An air conditioning apparatus according to a seventh aspect of the present invention comprises the electromagnetic induction heating unit according to any of the first through sixth aspects of the present invention; and a refrigeration cycle that includes a portion for leading refrigerant to the refrigerant tube.

In this air conditioning apparatus, effects on the periphery of the electromagnetic induction heating unit can be minimized even when electromagnetic induction heating is performed in the air conditioning apparatus.

### Advantageous Effects of the Invention

In the electromagnetic induction heating unit according to the first aspect of the present invention, the magnetic field that occurs in the portions other than the refrigerant tube can be efficiently made to pass through the magnetic member, and it is possible to minimize the degree of leakage to the portions other than the magnetic member in the area outside of the magnetic member.

In the electromagnetic induction heating unit according to the second aspect of the present invention, the efficiency of heating by electromagnetic induction can be enhanced in a case in which the longitudinal direction of the magnetic substance included in the refrigerant tube and the axial direction of the refrigerant tube are substantially the same.

In the electromagnetic induction heating unit according to the third aspect of the present invention, the magnetic member can be provided inexpensively and in the desired positions.

In the electromagnetic induction heating unit according to the fourth aspect of the present invention, the degree of leakage of the magnetic field that leaks from the refrigerant tube to portions other than the magnetic member is further reduced, and the magnetic field can be more efficiently made to pass through the magnetic member.

In the electromagnetic induction heating unit according to the fifth aspect of the present invention, since the lines of magnetic force include a good conductor material, Joule heat generated by electrical resistance can be minimized.

In the electromagnetic induction heating unit according to the sixth aspect of the present invention, lines of magnetic force that are further outside than the magnetic force line parts can be minimized.

In the air conditioning apparatus according to the seventh aspect of the present invention, effects on the periphery of the electromagnetic induction heating unit can be minimized.

### BRIEF DESCRIPTION OF THE DRAWINGS

FIG. 1 is a refrigerant circuit diagram showing an air conditioning apparatus according to an embodiment of the present invention.

FIG. 2 is an external perspective view showing the front side of an outdoor unit.

FIG. 3 is a perspective view showing the internal arrangement configuration of the outdoor unit.

FIG. 4 is a perspective view showing the positional relationship and the like between the outdoor heat exchanger and the bottom panel of the outdoor unit.

FIG. 5 is an external perspective view showing the back surface of the outdoor unit.

FIG. 6 is an external perspective view showing an electromagnetic induction heating unit.

FIG. 7 is a sectional view showing the configuration of the electromagnetic induction heating unit.

FIG. 8 is an external perspective view showing a state in which a screen cover is removed from the electromagnetic induction heating unit.

FIG. 9 is an external perspective view showing a bobbin main body on which a coil is wound.

FIG. 10 is a front view showing the bobbin main body.

FIG. 11 is a conceptual view showing the supply of power to the electromagnetic induction heating unit.

FIG. 12 is a bottom view showing a state in which the screen cover of the electromagnetic induction heating unit is removed.

FIG. 13 is a top view showing the portion positioned on the outside of a first bobbin lid.

FIG. 14 is a bottom view showing the portion positioned on the inside of the first bobbin lid.

FIG. 15 is an external perspective view showing a thermistor.

FIG. 16 is an external perspective view showing a fuse.

FIG. 17 is a view showing the magnetic flux that occurs in a state in which the screen cover is absent.

FIG. 18 is a view showing the magnetic flux that occurs in a state in which the screen cover is provided.

FIG. 19 is an external perspective view showing a first ferrite case in a state in which the ferrites are provided.

FIG. 20 is a plan view showing the first ferrite case.

FIG. 21 is a back view showing the first ferrite case.

FIG. 22 is a side view showing the first ferrite case.

FIG. 23 is a view showing the vicinity of a screwing part at the top side of the first ferrite case.

FIG. 24 is a view showing the vicinity of the screwing part at the bottom side of the first ferrite case.

FIG. 25 is a dimensional view showing the side surfaces and protrusions of the first ferrite case.

FIG. 26 is a plan view showing a first ferrite.

FIG. 27 is a view showing one side of the first ferrite.

FIG. 28 is a view showing another side of the first ferrite.

FIG. 29 is a plan view showing a second ferrite.

FIG. 30 is a view showing one side of the second ferrite.

FIG. 31 is a view showing another side of the second ferrite.

FIG. 32 is a side view showing the state in which the first ferrites and second ferrites are fixed.

FIG. 33 is a side view showing the ferrites according to another embodiment (A).

FIG. 34 is a side view showing the ferrites according to another embodiment (B).

FIG. 35 is an explanatory view showing a refrigerant tube according to another embodiment (D).

FIG. 36 is an explanatory view showing a refrigerant tube according to another embodiment (E).

FIG. 37 is a view showing an example of the arrangement of a coil and a refrigerant tube according to another embodiment (F).

FIG. 38 is a view showing an example of the arrangement of the bobbin lids according to another embodiment (F).

FIG. 39 is a view showing an example of the arrangement of the ferrite cases according to another embodiment (F).

FIG. 40 is a view showing an example of a different arrangement of the ferrites.

### DESCRIPTION OF EMBODIMENTS

The electromagnetic induction heating unit 6 and the air conditioning apparatus 1 provided therewith according to an embodiment of the present invention will be described below as examples with reference to the drawings.

<1-1> Air Conditioning Apparatus 1

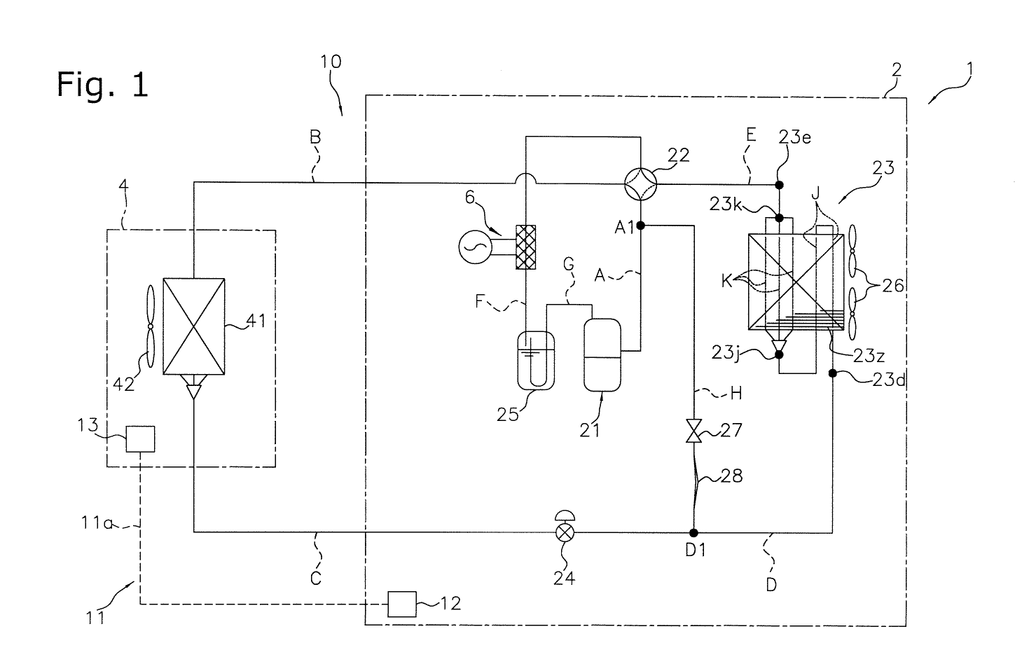

FIG. 1 is a refrigerant circuit diagram showing a refrigerant circuit 10 of the air conditioning apparatus 1.

In the air conditioning apparatus 1, an outdoor unit 2 as a heat source-side apparatus, and an indoor unit 4 as a usage-side apparatus are connected by a refrigerant tube, the air conditioning apparatus 1 performs air conditioning of a space in which a usage-side apparatus is placed, and the air conditioning apparatus 1 is provided with a compressor 21, a four-way switching valve 22, an outdoor heat exchanger 23, an outdoor motor-driven expansion valve 24, an accumulator 25, outdoor fans 26, an indoor heat exchanger 41, an indoor fan 42, a hot-gas bypass valve 27, a capillary tube 28, the electromagnetic induction heating unit 6, and other components.

The compressor 21, four-way switching valve 22, outdoor heat exchanger 23, outdoor motor-driven expansion valve 24, accumulator 25, outdoor fans 26, hot-gas bypass valve 27, capillary tube 28, and electromagnetic induction heating unit 6 are housed within the outdoor unit 2. The indoor heat exchanger 41 and the indoor fan 42 are housed within the indoor unit 4.

The refrigerant circuit 10 has a discharge tube A, an indoor-side gas tube B, an indoor-side liquid tube C, an indoor-side liquid tube D, an outdoor-side gas tube E, an accumulator tube F, an intake tube G, a hot-gas bypass circuit H, branch tubes K, and juncture tubes J. Large amounts of gas-state refrigerant pass through the indoor-side gas tube B and the outdoor-side gas tube E, but the refrigerant passing through is not limited to gas refrigerant. Large amount of liquid-state refrigerant pass through the indoor-side liquid tube C and the indoor-side liquid tube D, but the refrigerant passing through is not limited to liquid refrigerant.

The discharge tube A is connected to the compressor 21 and the four-way switching valve 22.

The indoor-side gas tube B is connected to the four-way switching valve 22 and the indoor heat exchanger 41.

The indoor-side liquid tube C is connected to the indoor heat exchanger 41 and the outdoor motor-driven expansion valve 24.

The indoor-side liquid tube D is connected to the outdoor motor-driven expansion valve 24 and the outdoor heat exchanger 23.

The outdoor-side gas tube E is connected to the outdoor heat exchanger 23 and the four-way switching valve 22.

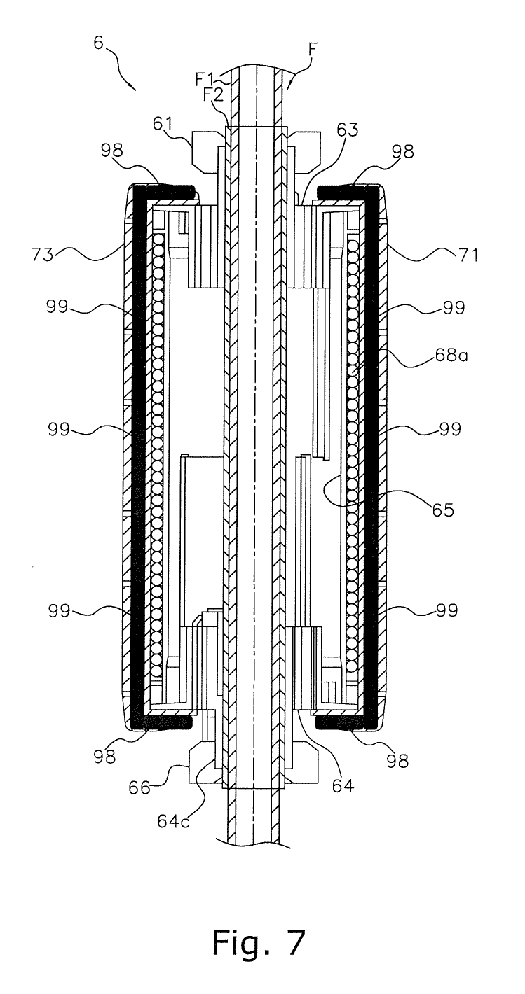

The accumulator tube F is connected to the four-way switching valve 22 and the accumulator 25, and extends in the vertical direction in the installed state of the outdoor unit 2. The electromagnetic induction heating unit 6 is attached to a portion of the accumulator tube F. At least the heated portion of the accumulator tube F that is covered by the electromagnetic induction heating unit 6 is composed of copper tubing F1 covered on the periphery thereof by SUS (Stainless Used Steel: stainless steel) tubing F2 (see FIG. 7). The portion other than the SUS tubing of the tube that constitutes the refrigerant circuit 10 is composed of copper tubing. The material of the tubing for covering the periphery of the abovementioned copper tubing is not limited to SUS, and may be iron, copper, aluminum, chrome, nickel, or another conductor, or an alloy or the like containing two or more types of metals selected from these metals, for example. Examples of the SUS include ferritic and martensitic SUS as well as combinations of these two types. The accumulator tube F herein also may not necessarily be provided with a magnetic substance or a material that includes a magnetic substance, and preferably includes the substance in which induction heating is to take place. The magnetic material may constitute the entire accumulator tube F, or may be used to form only the inside surface of the accumulator tube F, or may be present in the material constituting the accumulator tube F, for example. By this electromagnetic induction heating, the accumulator tube F can be heated by electromagnetic induction, and it is possible to heat the refrigerant that is drawn into the compressor 21 via the accumulator 25. The air-warming ability of the air conditioning apparatus 1 can thereby be enhanced. Even in a case in which the compressor 21 is not adequately warmed up at the start of air-warming operation, deficiency in performance can be overcome by the rapid heating provided by the electromagnetic induction heating unit 6. Furthermore, in a case in which the four-way switching valve 22 is switched to the state for air-cooling operation, and defrost operation is performed to remove frost from the outdoor heat exchanger 23, the electromagnetic induction heating unit 6 rapidly heats the accumulator tube F, and the compressor 21 can thereby compress rapidly warmed refrigerant. The temperature of the hot gas discharged from the compressor 21 can therefore be rapidly increased. The time needed for the defrost operation to melt the frost can thereby be shortened. It is thereby possible to return to air-warming operation as quickly as possible, and amenity to the customer can be enhanced even in a case in which a timely defrost operation must be performed during air-warming operation.

The intake tube G is connected to the accumulator 25 and the intake side of the compressor 21.

The hot-gas bypass circuit H connects a branch point A1 provided partway in the discharge tube A with a branch point D1 provided partway in the indoor-side liquid tube D.

The hot-gas bypass valve 27, which is capable of switching between a state of allowing passage refrigerant and a state of not allowing passage of refrigerant, is disposed partway in the hot-gas bypass circuit H.

The branch tubes K constitute a portion of the outdoor heat exchanger 23, and are tubes which are branched into a plurality of tubes formed by branching of the refrigerant tube, which extends from a gas-side outlet/inlet 23e of the outdoor heat exchanger 23, at a branch juncture point 23k described hereinafter, in order to increase the effective surface area for heat exchange. The branch tubes K extend from the branch juncture point 23k to a juncture branch point 23j, and merge at the juncture branch point 23j.

The juncture tubes J constitute a portion of the outdoor heat exchanger 23, and are tubes which extend from the juncture branch point 23j to a liquid-side outlet/inlet 23d of the outdoor heat exchanger 23. The juncture tubes J are capable of coordinating the degree of supercooling of the refrigerant that flows out from the outdoor heat exchanger 23 during air-cooling operation, and of thawing ice that forms in the vicinity of the lower end of the outdoor heat exchanger 23 during air-warming operation.

The four-way switching valve 22 is capable of switching between an air-cooling operation cycle and an air-warming operation cycle. In FIG. 1, the connection state for air-warming operation is indicated by solid lines, and the connection state for air-cooling operation is indicated by dashed lines. During air-warming operation, the indoor heat exchanger 41 functions as a refrigerant cooler, and the outdoor heat exchanger 23 functions as a refrigerant heater. During air-cooling operation, the outdoor heat exchanger 23 functions as a refrigerant cooler, and the indoor heat exchanger 41 functions as a refrigerant heater.

The outdoor heat exchanger 23 has the gas-side outlet/inlet 23e, the liquid-side outlet/inlet 23d, the branch juncture point 23k, the juncture branch point 23j, the branch tubes K, the juncture tubes J, and heat exchange fins 23z. The gas-side outlet/inlet 23e is positioned at an end part on the side of the outdoor-side gas tube E of the outdoor heat exchanger 23, and is connected to the outdoor-side gas tube E. The liquid-side outlet/inlet 23d is positioned at an end part on the side of the indoor-side liquid tube D of the outdoor heat exchanger 23, and is connected to the indoor-side liquid tube D. The branch juncture point 23k branches the tube that extends from the gas-side outlet/inlet 23e, and can branch or merge the refrigerant, depending on the direction of refrigerant flow. The branch tubes K extend as a plurality of tubes from branching portions at the branch juncture point 23k. The juncture branch point 23j merges the branch tubes K and can merge or branch the refrigerant, depending on the direction of refrigerant flow. The juncture tubes J extend from the juncture branch point 23j to the liquid-side outlet/inlet 23d. The heat exchange fins 23z are composed of a plurality of plate-shaped aluminum fins aligned in the plate thickness direction and arranged at a predetermined interval. The branch tubes K and the juncture tubes J all pass through the heat exchange fins 23z in common. Specifically, the branch tubes K and the juncture tubes J are arranged so as to pass through different portions of the same heat exchange fins 23z in the plate thickness direction thereof.

An outdoor controller 12 for controlling the devices provided in the outdoor unit 2, and an indoor controller 13 for controlling the devices provided in the indoor unit 4 are connected by a communication line 11a, and a controller 11 is thereby formed. The controller 11 performs various types of control of the air conditioning apparatus 1.

<1-2> Outdoor Unit 2

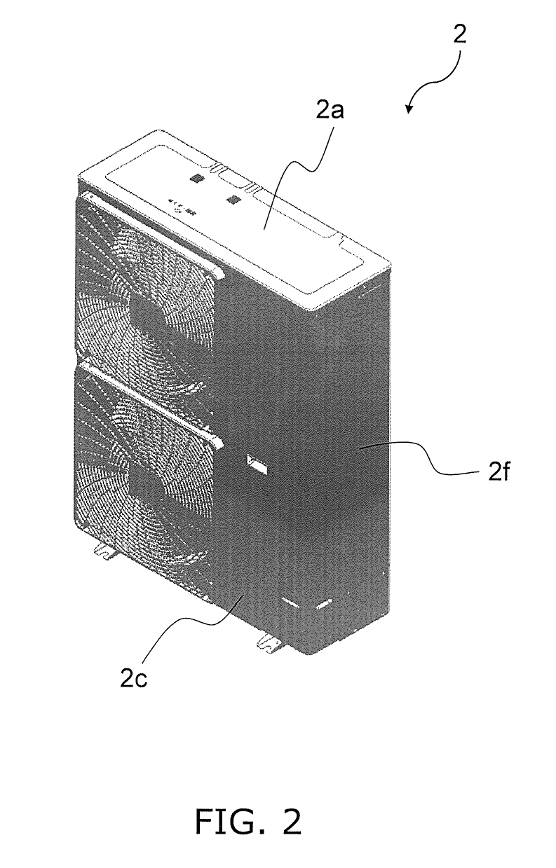

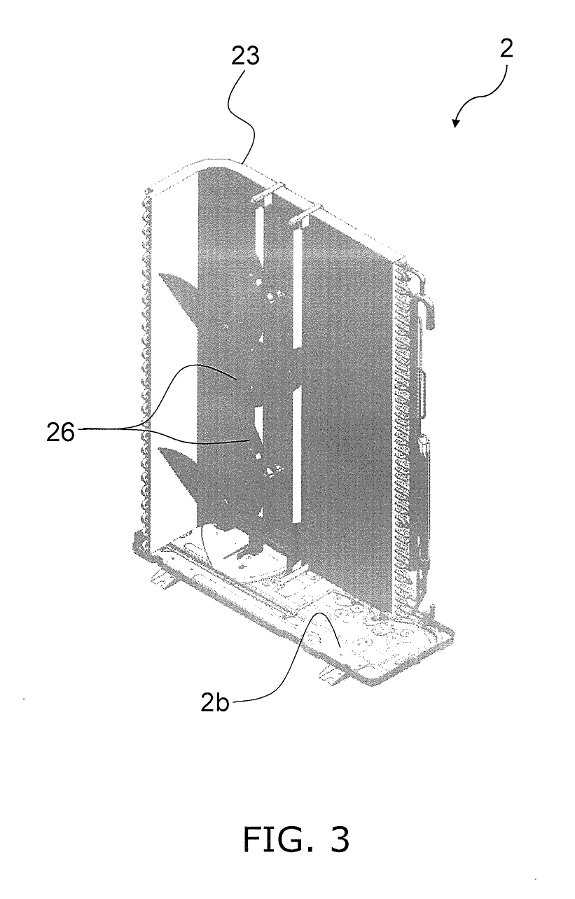

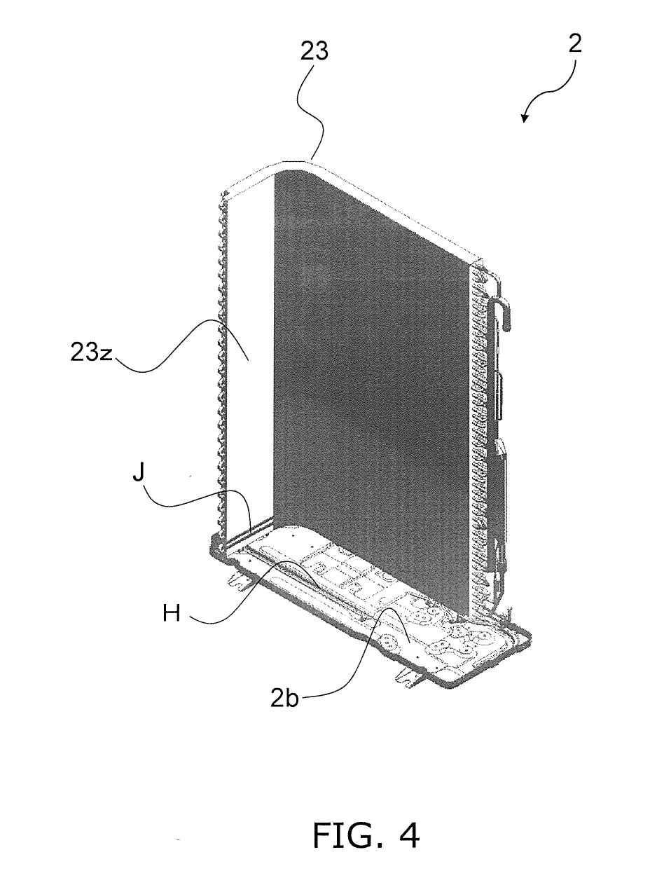

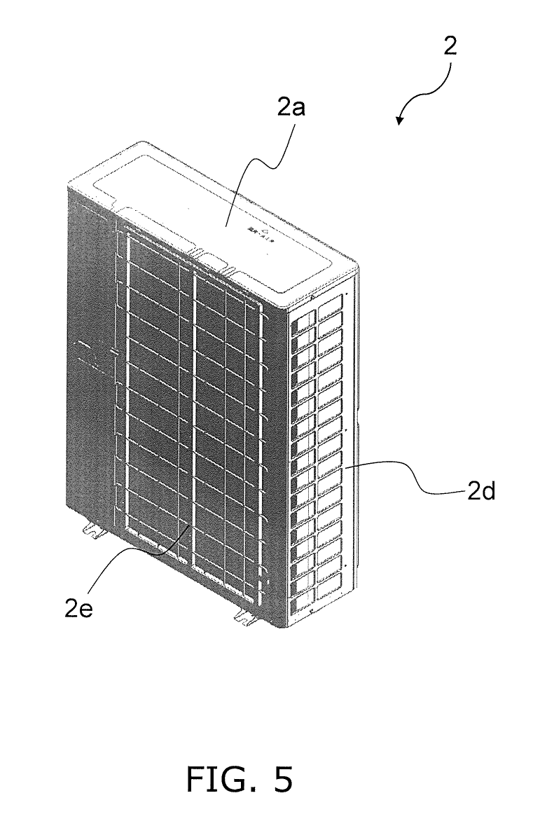

FIG. 2 is an external perspective view showing the front side of the outdoor unit 2. FIG. 3 is an external perspective view showing the back side of the outdoor unit 2. FIG. 4 is a perspective view showing the positional relationship between the outdoor heat exchanger 23 and the outdoor fans 26. FIG. 5 is a perspective view showing the positional relationship between the outdoor heat exchanger 23 and a bottom plate 2b.

The external surfaces of the outdoor unit 2 are formed by a substantially rectangular column-shaped outdoor-unit casing composed of a top plate 2a, a bottom plate 2b, a front panel 2c, a left-side panel 2d, a right-side panel 2f, and a back panel 2e.

The outdoor unit 2 is divided via a partitioning plate (not shown) into a blower chamber on the side of the left-side panel 2d, in which the outdoor heat exchanger 23, outdoor fans 26, and other components are disposed, and a machine chamber on the side of the right-side panel 2f, in which the compressor 21 and the electromagnetic induction heating unit 6 are disposed. The electromagnetic induction heating unit 6 is disposed in the machine chamber at an upper position in the vicinity of the left-side panel 2d and the top plate 2a. The plurality of heat exchange fins 23z of the outdoor heat exchanger 23 described above are arranged in the plate thickness direction so that the plate thickness direction is substantially horizontal. The juncture tubes J are arranged by passing through the heat exchange fins 23z in the thickness direction thereof in the lowest portion of the heat exchange fins 23z of the outdoor heat exchanger 23. The hot-gas bypass circuit H is disposed below the outdoor fans 26 and along the bottom of the outdoor heat exchanger 23.

<1-3> Electromagnetic Induction Heating Unit 6

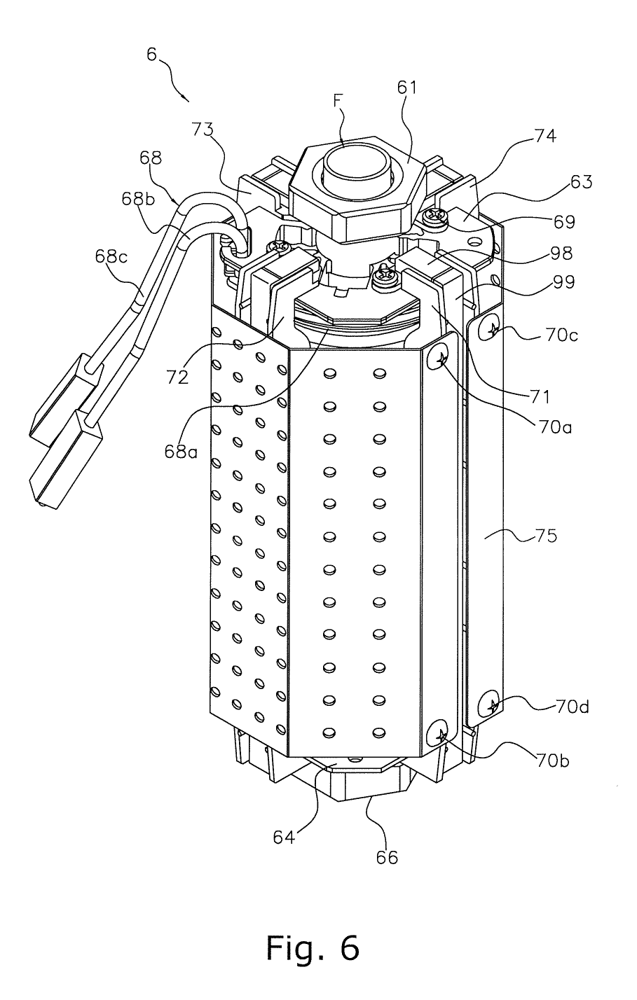

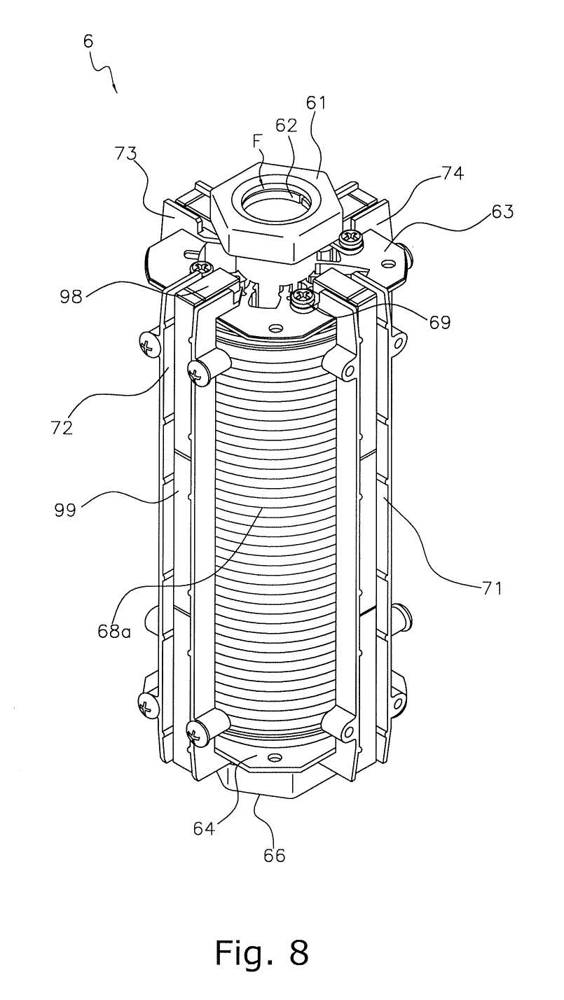

FIG. 6 is a rough perspective view showing the electromagnetic induction heating unit 6. FIG. 7 is a sectional view showing the electromagnetic induction heating unit 6. FIG. 8 is an external perspective view showing a state in which the screen cover 75 is removed from the electromagnetic induction heating unit 6.

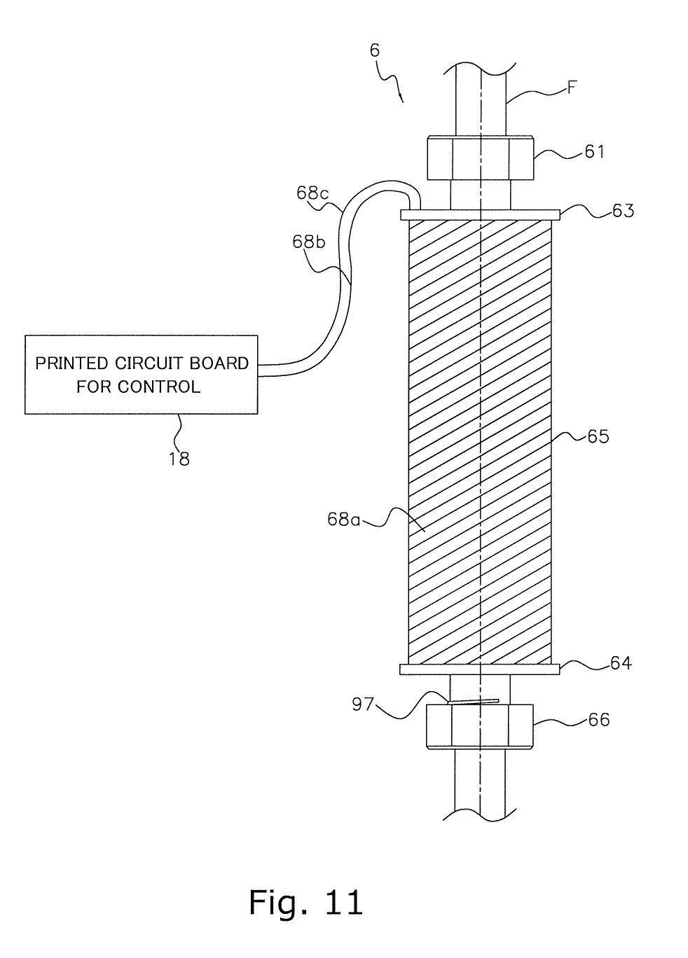

The electromagnetic induction heating unit 6 is provided so as to cover the heated portion of the accumulator tube F from the outside in the radial direction thereof, and heats the heated portion by electromagnetic induction heating. The heated portion of the accumulator tube F has a two-layer tubing structure which has copper tubing F1 on the inside and SUS tube F2 on the outside thereof. Before the electromagnetic induction heating unit 6 is fixed to the accumulator tube F, a binding 97 such as the one shown in FIG. 11 is used to position the electromagnetic induction heating unit 6 with respect to the accumulator tube F. The operation of fixing can thereby be performed while the electromagnetic induction heating unit 6 is in position with respect to the accumulator tube F, and workability is enhanced.

The electromagnetic induction heating unit 6 is provided with a first hexagonal nut 61, a second hexagonal nut 66, a C-ring 62, a first bobbin lid 63, a second bobbin lid 64, a bobbin main body 65, a first ferrite case 71, a second ferrite case 72, a third ferrite case 73, a fourth ferrite case 74, a first ferrite 98, a second ferrite 99, a coil 68, a screen cover 75, a thermistor 14, and a fuse 15.

The first hexagonal nut 61 is made of resin, and fixes the electromagnetic induction heating unit 6 in the vicinity of the top end of the accumulator tube F. The second hexagonal nut 66 is made of resin, and fixes the electromagnetic induction heating unit 6 in the vicinity of the bottom end of the accumulator tube F.

The C-ring 62 is made of resin, and is fixed in surface contact with the accumulator tube F in cooperation with the first hexagonal nut 61 and the first bobbin lid 63. Although not shown in the drawing, the C-ring 62 is also fixed in surface contact with the accumulator tube F in cooperation with the second hexagonal nut 66 and the second bobbin lid 64.

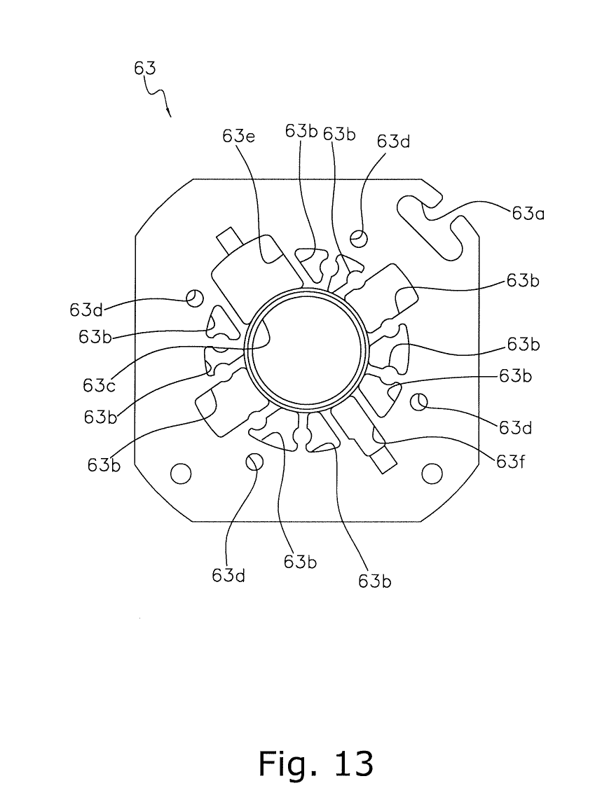

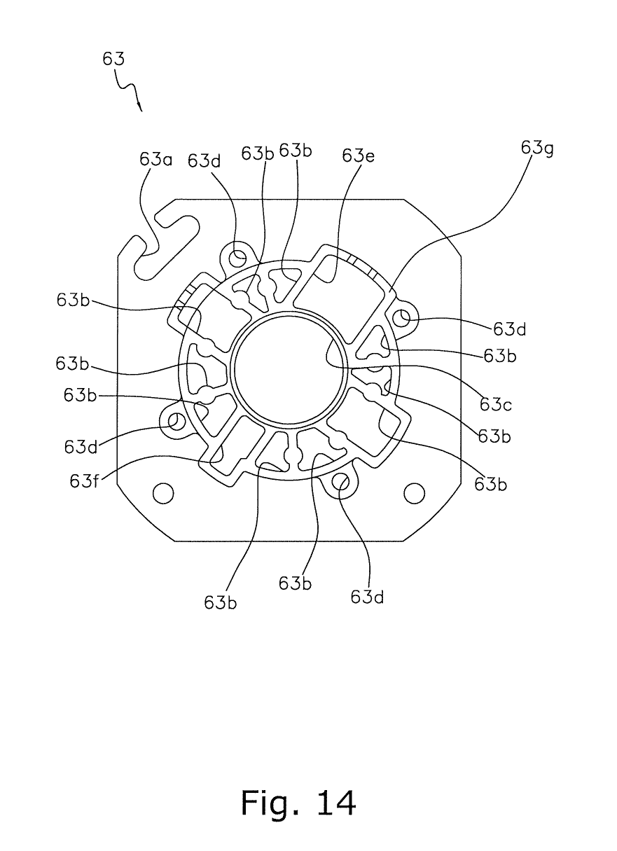

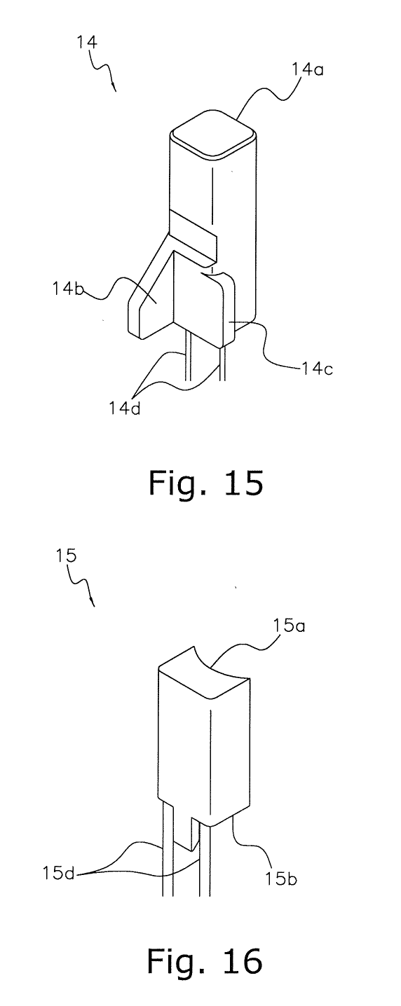

The first bobbin lid 63 is made of resin, is one of the members for determining the relative positioning of the accumulator tube F and the coil 68 in the electromagnetic induction heating unit 6, and covers the accumulator tube F from the periphery thereof above the electromagnetic induction heating unit 6. The second bobbin lid 64 is made of resin, has the same shape as the first bobbin lid 63, and covers the accumulator tube F from the periphery thereof below the electromagnetic induction heating unit 6. FIG. 13 is a top view showing the first bobbin lid 63. FIG. 14 is a bottom view showing the first bobbin lid 63. The first bobbin lid 63 has a cylindrical part 63c for the tube, for fixing the accumulator tube F and the electromagnetic induction heating unit 6 in cooperation with the first hexagonal nut 61 and the C-ring 62 while allowing the accumulator tube F to pass through. The first bobbin lid 63 has a substantially T-shaped hook-shaped part 63a formed toward the inside from the external peripheral portion, for retaining a coil first portion 68b and a coil second portion 68c while allowing the coil first portion 68b and coil second portion 68c to pass through. The first bobbin lid 63 has a plurality of radiating openings 63b which run through in the vertical direction in order to dissipate heat that accumulates between the bobbin main body 65 and the SUS tube F2 to the outside. The first bobbin lid 63 has four screw holes 63d for screws 69, for screwing the first through fourth ferrite cases 71 through 74 via the screws 69. The first bobbin lid 63 also has a fuse insertion opening 63e and a thermistor insertion opening 63f. The fuse insertion opening 63e is an opening used for attaching the fuse 15 shown in FIG. 16, and has a shape which conforms to the outer edge shape of the fuse 15 as viewed in the insertion direction thereof. The thermistor insertion opening 63f is an opening used for attaching the thermistor 14 shown in FIG. 15, and has a shape which conforms to the outer edge shape of the thermistor 14 as viewed in the insertion direction thereof. Since the thermistor 14 and the fuse 15 are attached from below the electromagnetic induction heating unit 6, the thermistor insertion opening 63f and fuse insertion opening 63e of the first bobbin lid 63 perform the same radiating function as the radiating openings 63b. Since the warm air to be radiated accumulates in the upper space inside the bobbin main body 65, providing more radiating openings at the top than at the bottom enables efficient heat dissipation. The thermistor 14 is inserted in the thermistor insertion opening 63f of the second bobbin lid 64, the fuse 15 is inserted in the fuse insertion opening 63e of the second bobbin lid 64, and the thermistor 14 and fuse 15 are each attached. As shown in FIG. 14, on the bottom side of the first bobbin lid 63, a bobbin cylinder top part 63g extends downward for fitting with the bobbin main body 65 by being positioned on the inside of a top end cylindrical part (described hereinafter) of the bobbin main body 65. So as not to close the passage state of the radiating openings 63b, screw holes 63d, fuse insertion opening 63e, and thermistor insertion opening 63f described above, the bobbin cylinder top part 63g is formed so as to extend in the passage direction from a portion that conforms to the outer edges of each opening. The openings and shape of the first bobbin lid 63 are the same as in the second bobbin lid 64, the reference numerals beginning with 63 for each member of the first bobbin lid 63 correspond to the reference numerals beginning with 64 for each member of the second bobbin lid 64, and no further description of these corresponding members will be given.

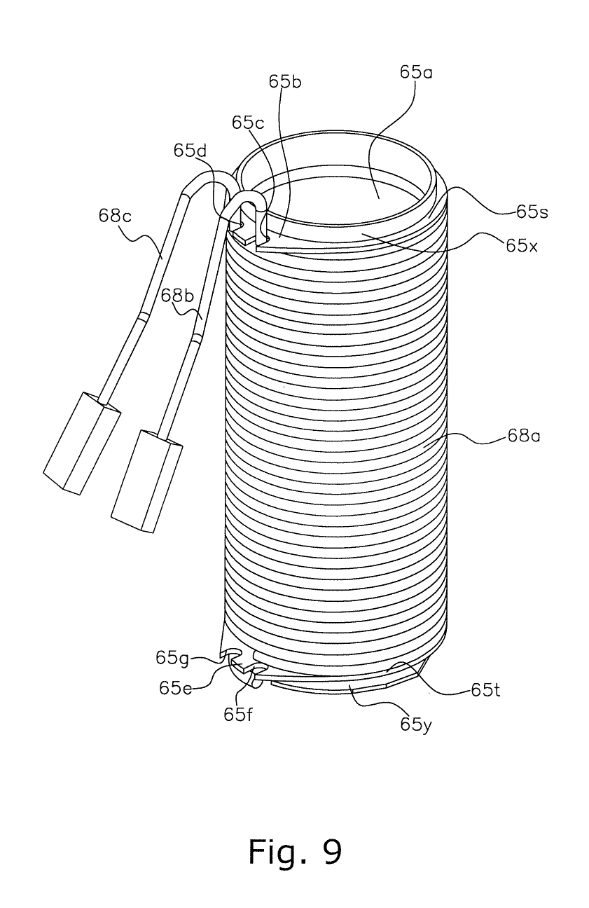

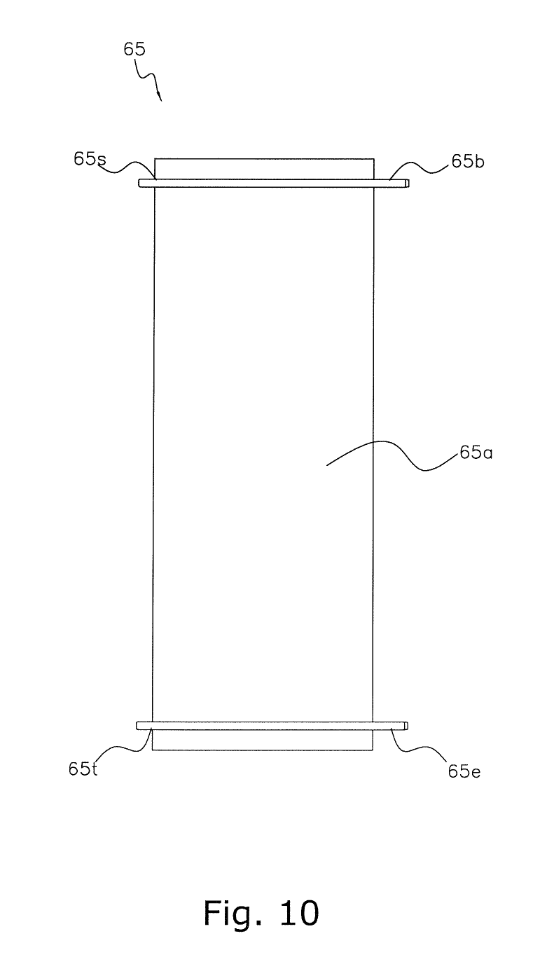

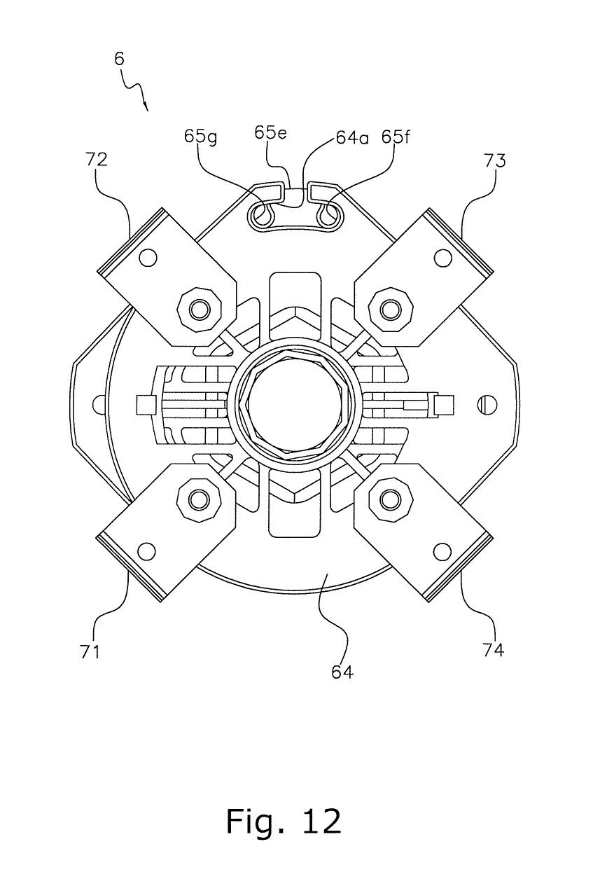

The coil 68 is wound around the bobbin main body 65, as shown in FIG. 9. As shown in FIG. 10, the bobbin main body 65 has a cylindrical part 65a having a cylindrical shape. The bobbin main body 65 has a first winding stop 65s formed so as to protrude in the radial direction at a portion slightly lower than the top end, and a second winding stop 65t formed so as to protrude in the radial direction at a portion slightly higher than the bottom end. A top end cylindrical part 65x extends upward from the first winding stop 65s. A bottom end cylindrical part 65y extends downward from the second winding stop 65t. The first winding stop 65s has a first coil retaining part 65b that protrudes further outward in the radial direction. The first coil retaining part 65b has a coil retaining groove 65c formed as an indentation in the radial direction to hold the coil first portion 68b therein, and a coil retaining groove 65d formed as an indentation in the radial direction to hold the coil second portion 68c therein. The second winding stop 65t has a second coil retaining part 65e in which coil retaining grooves 65f, 65g are formed, in the same manner as in the first winding stop 65s. As shown in the bottom view of the electromagnetic induction heating unit 6 in FIG. 12, the outsides of the coil retaining grooves 65f, 65g formed in the bobbin main body 65 are covered by a hook-shaped part 64a of the second bobbin lid 64, and the coil first portion 68b and coil second portion 68c can thereby be more reliably retained. Since the coil retaining grooves 65f, 65g and the hook-shaped part 64a are offset in the direction in which the accumulator tube F extends, the coil first portion 68b and the coil second portion 68c can be retained at a plurality of locations in the extension direction thereof. Localized loads on the coil 68 can therefore be made less prone to occur. In the bobbin main body 65, a space is formed between the bobbin main body 65 and the accumulator tube F on the inside toward the accumulator tube F, and a distance is provided so that the magnetic flux that forms when current is fed to the coil 68 more efficiently passes through the SUS tube F2 of the accumulator tube F.

The first ferrite case 71 holds the first bobbin lid 63 and the second bobbin lid 64 from the direction in which the accumulator tube F extends. The first ferrite case 71 has a portion for accommodating the first ferrite 98 and second ferrite 99 described hereinafter. The second ferrite case 72, third ferrite case 73, and fourth ferrite case 74 are the same as the first ferrite case 71, and are disposed in positions so as to cover the bobbin main body 65, first bobbin lid 63, and second bobbin lid 64 from the outside in four directions. As shown in FIGS. 6, 8, and 12, the first bobbin lid 63 is screwed via metal screws 69 and fixed to each of the first through fourth ferrite cases 71 through 74.

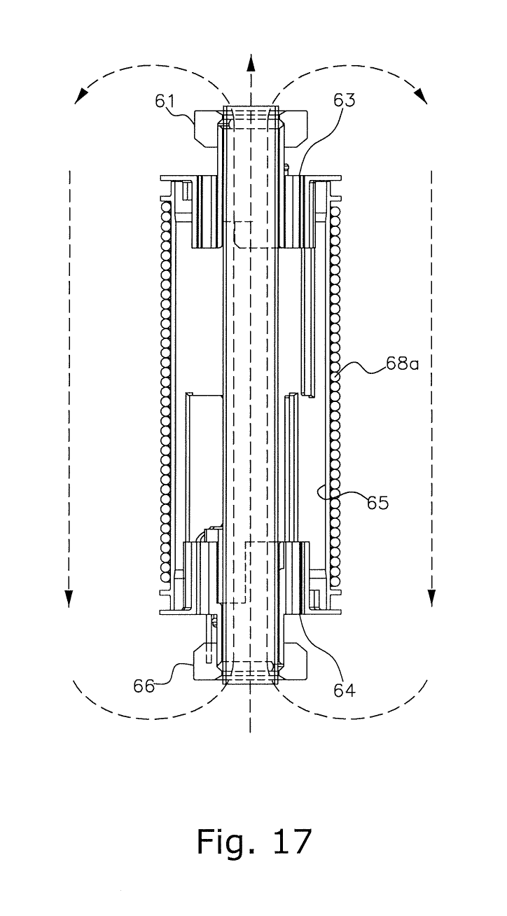

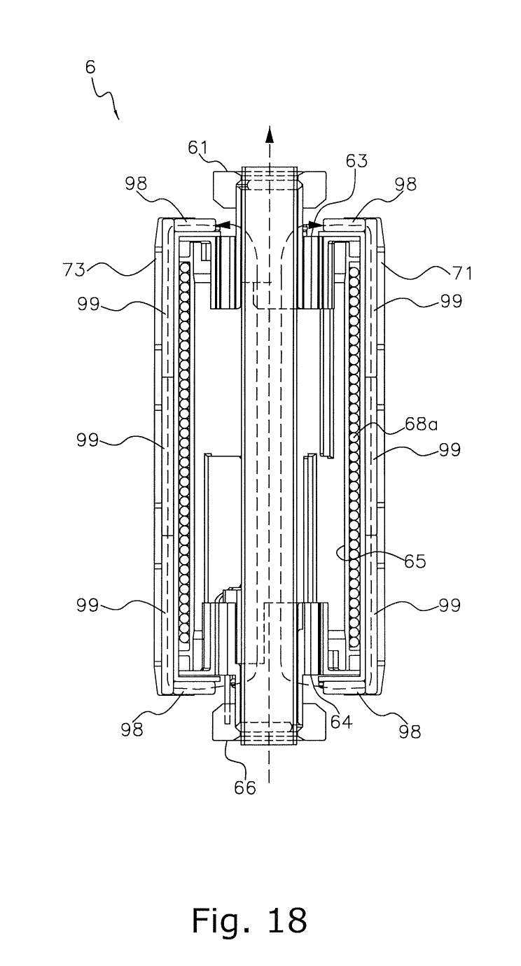

The first ferrite 98 is composed of a ferrite material having high magnetic permeability, and when current is fed to the coil 68, the first ferrite 98 collects the magnetic flux that occurs in portions outside the SUS tube F2 as well and forms a path for the magnetic flux. The first ferrite 98 is accommodated particularly in the accommodating parts of the first through fourth ferrite cases 71 through 74 near the top and bottom ends of the electromagnetic induction heating unit 6. The second ferrite 99 is the same as the first ferrite 98, other than with respect to the position and shape thereof, and is disposed at a position near the outside of the bobbin main body 65 in the accommodating parts of the first through fourth ferrite cases 71 through 74. In a case in which the first ferrite 98 and second ferrite 99 are not provided, the magnetic flux leaks out on the periphery as shown in FIG. 17, for example. In the electromagnetic induction heating unit 6 of the present embodiment, however, since the first ferrite 98 and second ferrite 99 are provided on the outside of the coil 68, the magnetic flux flow as shown in FIG. 18, and leakage flux can be reduced.

The coil 68 has a coil winding portion 68a that is helically wound on the outside of the bobbin main body 65 with the extension direction of the accumulator tube F as the axial direction, a coil first portion 68b that extends at one end of the coil 68 with respect to the coil winding portion 68a, and a coil second portion 68c that extends at the other end, on the opposite side from the one end of the coil 68. This coil 68 is positioned inside the first through fourth ferrite cases 71 through 74. The coil first portion 68b and the coil second portion 68c are connected to a printed circuit board 18 for control, as shown in FIG. 11. The coil 68 receives a high-frequency current fed from the printed circuit board 18 for control. The printed circuit board 18 for control is controlled by the controller 11. When the fed high-frequency current is received, the coil winding portion 68a generates a magnetic flux. Specifically, as indicated by dashed lines in FIG. 18, a magnetic flux occurs which is substantially elliptical on the plane extending in the axial direction and in the radial direction with respect to the accumulator tube F, through the portion of the SUS tube F2 closest to the coil winding portion 68a, and the portions of the first ferrite 98, second ferrite 99, and screen cover 75 closest to the coil winding portion 68a. The magnetic flux thus formed causes a current (eddy current) to occur by electromagnetic induction in the SUS tube F2. As a current flows through the SUS tube F2, heat is evolved in a portion thereof that acts as an electrical resistor. Merely by winding the coil 68 on the outside of the bobbin main body 65, the coil 68 can be placed so that the axial direction thereof is substantially the same as the axial direction of the SUS tube F2. By providing the coil 68 in a substantially cylindrical shape, more magnetic flux can be supplied to the SUS tube F2 of the accumulator tube F, and the efficiency of heating can be enhanced. Copper wire, which is a good conductor, is used as the material of the coil 68 herein for the sake of efficiency in generating a magnetic flux. The material of the coil 68 is not particularly limited insofar as the material conducts electricity.

As is apparent by comparing FIG. 6 and FIG. 8, the screen cover 75 is disposed on the outermost peripheral portion of the electromagnetic induction heating unit 6, and collects the magnetic flux that cannot be held in by only the first ferrite 98 and the second ferrite 99. As shown in FIG. 6, the screen cover 75 is screwed and fixed to the first ferrite case 71 via screws 70a, 70b, 70c, 70d. Through this configuration, there is almost no leakage flux on the outside of the screen cover 75 in the electromagnetic induction heating unit 6, and the areas in which magnetic flux occurs can be self-determined.

As shown in FIG. 15, the thermistor 14 is attached so as to be in direct contact with the external surface of the accumulator tube F, and the thermistor 14 has a thermistor detector 14a, an outside protrusion 14b, a lateral protrusion 14c, and thermistor wires 14d. The thermistor 14 is in direct contact with the external surface of the accumulator tube F on the downstream side in the refrigerant flow direction of the portion of the accumulator tube F to which the electromagnetic induction heating unit 6 is attached. Specifically, the thermistor 14 is in direct contact with the external surface of the accumulator tube F at a point downstream from the center position in the width of the coil 68, in the refrigerant flow direction of the accumulator tube F. The thermistor detector 14a is shaped so as to conform to the curved shape of the external surface of the accumulator tube F, and has a surface area of substantial contact. The outside protrusion 14b is a protrusion which protrudes in the direction away from the accumulator tube F in a state in which the thermistor 14 is attached, and the shape of the outside protrusion 14b conforms to the edge of the thermistor insertion opening 63f of the second bobbin lid 64. The lateral protrusion 14c is also shaped so as to conform to the edge of the thermistor insertion opening 63f of the second bobbin lid 64 in the same manner as the outside protrusion 14b, and the lateral protrusion 14c extends away from the outside protrusion 14b. The thermistor wires 14d transmit the detection result of the thermistor detector 14a as a signal to the controller 11. On the basis of the detection result of the thermistor detector 14a, the controller 11 controls the fed amount of high-frequency current via the printed circuit board 18 for control, and controls the compressor 21, outdoor motor-driven expansion valve 24, outdoor fans 26, and indoor fan 42. Specifically, the thermistor 14 is in direct contact with the external surface of the accumulator tube F at a point downstream from the center position in the width of the coil 68, in the refrigerant flow direction of the accumulator tube F. The thermistor 14 is inserted upward in FIG. 15, but because the thermistor 14 has the outside protrusion 14b and the lateral protrusion 14c, the thermistor 14 has an asymmetrical shape as viewed from the insertion direction, the same as the thermistor insertion opening 63f. Errors can therefore be prevented in the attachment of the thermistor 14, and attachment workability is enhanced. In the present embodiment, the detection value of the thermistor 14 is used only for control of the electromagnetic induction heating unit 6 and not for other control. In other words, the thermistor 14 is provided as a detector dedicated for control of the electromagnetic induction heating unit 6.

As shown in FIG. 16, the fuse 15 is attached so as to be in direct contact with the external surface of the accumulator tube F, and has a fuse detector 15a, an asymmetrical shape 15b, and fuse wires 15d. The fuse detector 15a has an indented shape which is curved so as to conform to the curved shape of the external surface of the accumulator tube F, and the fuse detector 15a has a surface area of substantial contact. The asymmetrical shape 15b is inserted upward in FIG. 16, the same as the thermistor 14 described above, but has an asymmetrical shape as viewed from the insertion direction, the same as the fuse insertion opening 63e. Errors can therefore be prevented in the attachment of the fuse 15, and attachment workability is enhanced.

<1-4> Ferrite Cases 71 through 74

The ferrite cases will be described in detail below.

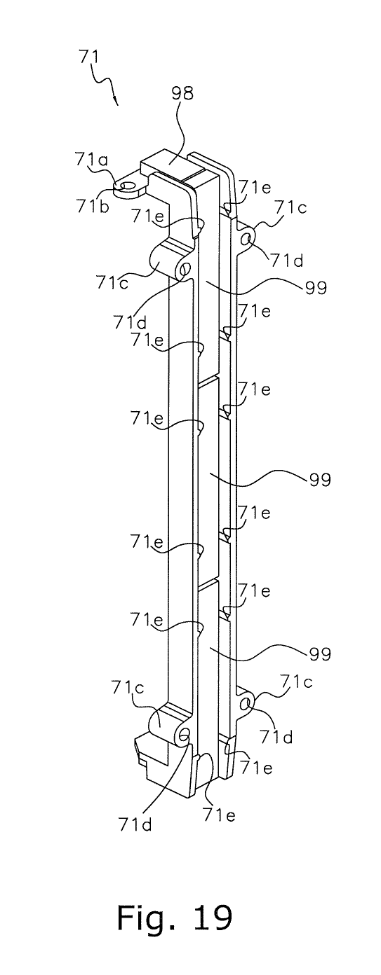

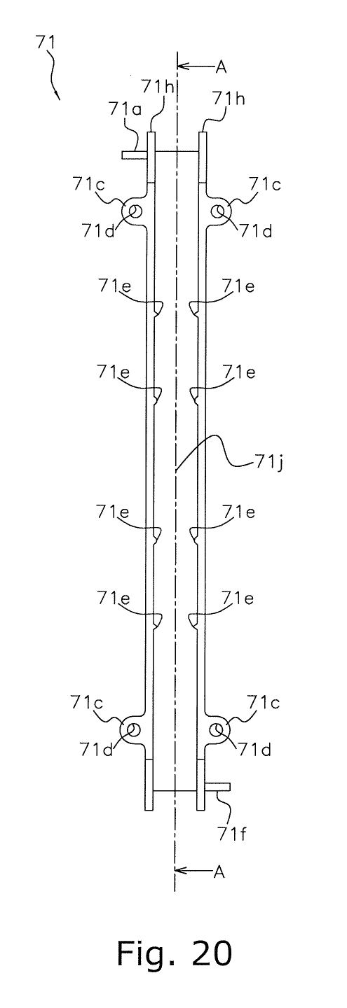

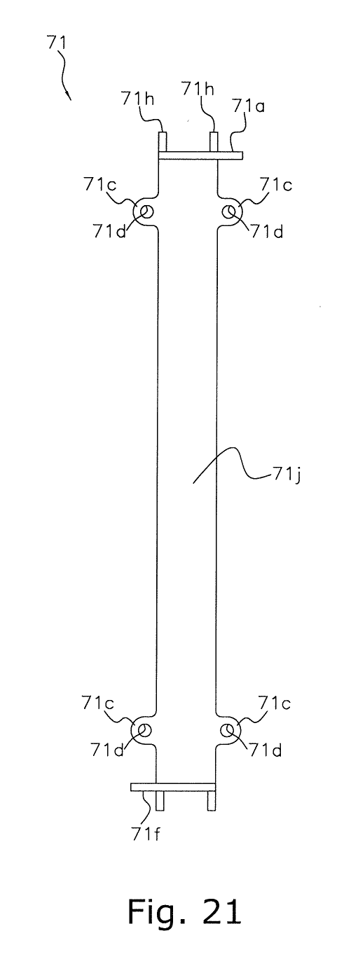

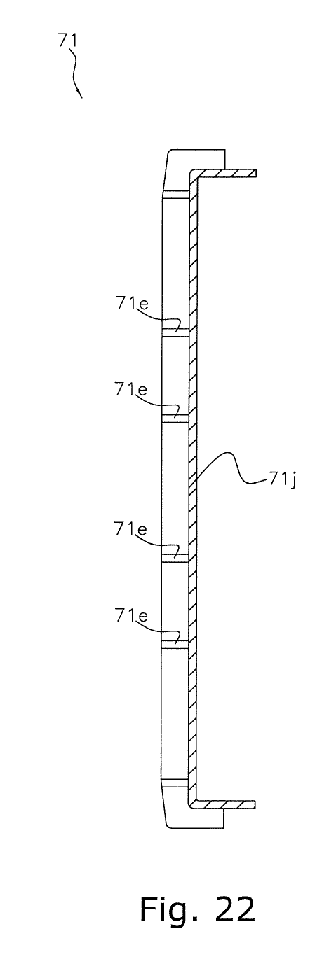

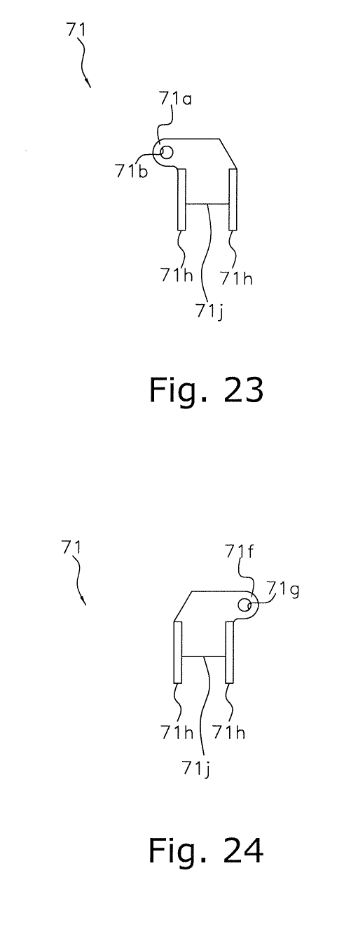

FIG. 19 is a schematic perspective view showing the first ferrite case 71 to which the first ferrites 98 and second ferrites 99 are attached. FIG. 20 is a plan view showing the first ferrite case 71. FIG. 21 is a back view showing the first ferrite case 71. FIG. 22 is a side view showing the first ferrite case 71. FIG. 23 is a view showing the vicinity of the screwing part at the top side of the first ferrite case 71. FIG. 24 is a view showing the vicinity of the screwing part at the bottom side of the first ferrite case 71.

Since the first through fourth ferrite cases 71 through 74 all have the same shape, the first ferrite case 71 will be described herein as a representative example, and no descriptions of the second through fourth ferrite cases 72 through 74 will be given.

The first ferrite case 71 is made of resin, and as shown in FIG. 8, the first ferrite case 71 has the functions of holding the first bobbin lid 63 and the second bobbin lid 64 therebetween such that they are fixed in the direction in which the accumulator tube F extends, and of accommodating and retaining the first ferrites 98 and the second ferrites 99.

The first ferrite case 71 has a bottom surface part 71j, side surfaces 71h, protrusions 71e, a first lid screwing part 71a, a first lid screwing hole 71b, a second lid screwing part 71f, a second lid screwing hole 71g, screen cover screwing parts 71c, and screen cover screwing holes 71d.

The bottom surface part 71j constitutes the bottom surface of the first ferrite case 71. As described hereinafter, the first ferrites 98 and the second ferrites 99 are bonded to the bottom surface part 71j. In the state in which the bottom surface part 71j is fixed to the electromagnetic induction heating unit 6, the surface of the bottom surface part 71j is positioned in the radial direction, and the longitudinal direction of the bottom surface part 71j is aligned with the direction in which the accumulator tube F extends. The bottom surface part 71j is attached to any of the four substantially linear symmetrical sides of the outer edge of the first bobbin lid 63 and second bobbin lid 64 in the radial direction. The back side of the bottom surface part 71j and the substantially linear sides of the first bobbin lid 63 and second bobbin lid 64 are thereby fixed in contact with each other. The first ferrite case 71 is thereby structured so that movement thereof in the peripheral direction is restricted.

The side surfaces 71h have surfaces which extend in the direction away from the bottom surface part 71j from both ends of the bottom surface part 71j in the direction orthogonal to the longitudinal direction thereof.

The protrusions 71e are formed so as to protrude toward each other from each of the two side surfaces 71h. The protrusions 71e are configured so as to allow insertion of a fingernail or finger of a worker during attachment of the first ferrites 98 and second ferrites 99, and enable working efficiency to be enhanced. Since the protrusions 71e are formed in protruding fashion so as to hold the space in which the first ferrites 98 and second ferrites 99 can be accommodated therebetween, the first ferrites 98 and second ferrites 99 can also be held therebetween in position.

The first lid screwing part 71a is provided for screwing together the first ferrite case 71 and the first bobbin lid 63, and is provided in a position offset from an imaginary space that extends in the radial direction from between the two side surfaces 71h. The first ferrites 98 can thereby be provided in the vicinity of the SUS tube F2, and leakage of magnetic force can be reduced.

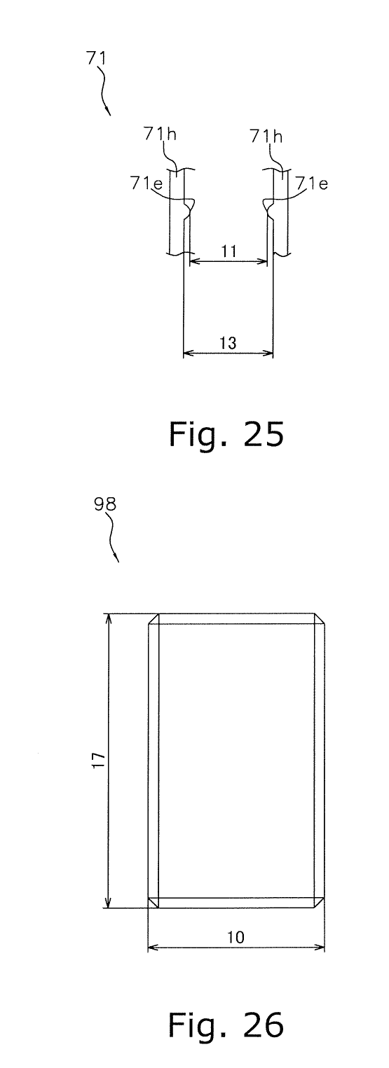

As shown in FIG. 25, the side surfaces 71h are formed at an interval of 13 mm. The protrusions 71e are also formed so that the distance between the distal end parts thereof is 11 mm.

The first lid screwing hole 71b is for screwing and fixing the first ferrite case 71 and the first bobbin lid 63 to each other. Specifically, as shown in FIG. 6, the first lid screwing hole 71b is for screwing together the first lid screwing hole 71b of the first ferrite case 71 and the screw hole 63d for a screw 69 of the first bobbin lid 63 through the use of the metal screw 69.

The second lid screwing part 71f is provided for screwing together the first ferrite case 71 and the second bobbin lid 64, and is provided in a position offset toward the opposite side from the first lid screwing part 71a from an imaginary space that extends in the radial direction from between the two side surfaces 71h. The first ferrites 98 can thereby be provided in the vicinity of the SUS tube F2, and leakage of magnetic force can be reduced. Since the first lid screwing part 71a and the second lid screwing part 71f are disposed on one side and the other side with respect to the imaginary space that extends in the radial direction from between the two side surfaces 71h, not only can leakage of magnetic force be reduced, but the first ferrite case 71 can be more securely fixed to the first bobbin lid 63 and second bobbin lid 64.

The second lid screwing hole 71g is for screwing and fixing the first ferrite case 71 and the second bobbin lid 64 to each other. Specifically, the second lid screwing hole 71g is for screwing together the second lid screwing hole 71g of the first ferrite case 71 and a screw hole 64d (not shown) for the screw 69 of the second bobbin lid 64 by the metal screw 69, in the same manner as in the above described first lid screwing hole 71b.

The screen cover screwing parts 71c are formed so as to swell toward the opposite side from the side on which the protrusions 71e protrude, and the screen cover screwing parts 71c are provided in two upper locations and two lower locations.

The screen cover screwing holes 71d are openings provided to each of the screen cover screwing parts 71c, and as shown in FIG. 6, in the state in which the screen cover 75 is attached, screws 70a, 70b, 70c, and 70d are screwed therein. The first ferrite case 71 and the screen cover 75 are thereby fixed. The screen cover screwing parts 71c and the screen cover screwing holes 71d are also provided to the second through fourth ferrite cases 72 through 74, but the screen cover 75 is actually fixed to only one of the ferrite cases, which is the first ferrite case 71 in the present embodiment.

As shown in FIG. 22, the cross-sectional shape of the first ferrite case 71 is substantially C-shaped in the plane that includes the center of gravity of the first ferrite case 71 in the installed state thereof and the axial direction of the accumulator tube F. The first bobbin lid 63 and the second bobbin lid 64 can be inserted in the substantially C-shaped first ferrite case 71. Through this configuration, even when there is error in the distance between the position of connection with the first bobbin lid 63 and the position of connection with the second bobbin lid 64, the error can be absorbed by elastic deformation of the C-shaped first ferrite case 71, whereby the first ferrite case 71 lengthens in the longitudinal direction thereof.

<1-5> Ferrites 98, 99

The ferrites will be described in detail below.

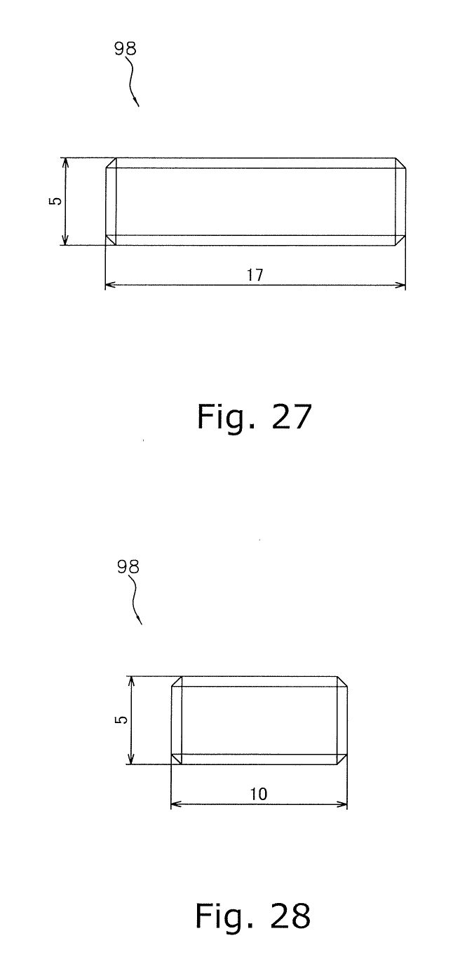

FIG. 26 is a plan view showing the first ferrite 98. FIG. 27 is a view showing one side of the first ferrite 98. FIG. 28 is a view showing another side of the first ferrite 98.

The first ferrite 98 has a substantially rectangular shape, and is composed of a ferrite that is a magnetic material and a good conductor. This ferrite is formed by sintering, and is therefore difficult to form into a complex shape. A ferrite having a complex shape is therefore more expensive than a ferrite having a simple shape. In this specific ferrite, the magnetic permeability is 1600 or higher under conditions of 0.1 MHz. The saturation flux density is 450 mT or higher under conditions of 1200 A/m. The residual flux density is 400 mT or lower under conditions of 1200 A/m. The holding power is 32 A/m or lower under conditions of 1200 A/m. The Curie temperature is 200° C. or higher.

As shown in FIGS. 6 and 19, the first ferrites 98 are fixed by bonding in attachment positions at the top end and bottom end in the accommodating spaces of each of the first through fourth ferrite cases 71 through 74 in the electromagnetic induction heating unit 6. Since the first ferrites 98 are thus disposed in the vicinity of the top end and bottom end of the SUS tube F2, the degree to which the magnetic field that leaks from the SUS tube F2 leaks to portions other than the first ferrites 98 and second ferrites 99 is minimized, and the magnetic field can be efficiently made to pass through the inside of the first ferrites 98 and the second ferrites 99. The length dimension of the first ferrite 98 in the radial direction is 17 mm when the first ferrite 98 is fixed. The dimension thereof in the direction in which the accumulator tube F extends is 5 mm when the first ferrite 98 is fixed. The dimension of the portion held between the side surfaces 71h is 10 mm when the first ferrite 98 is fixed.

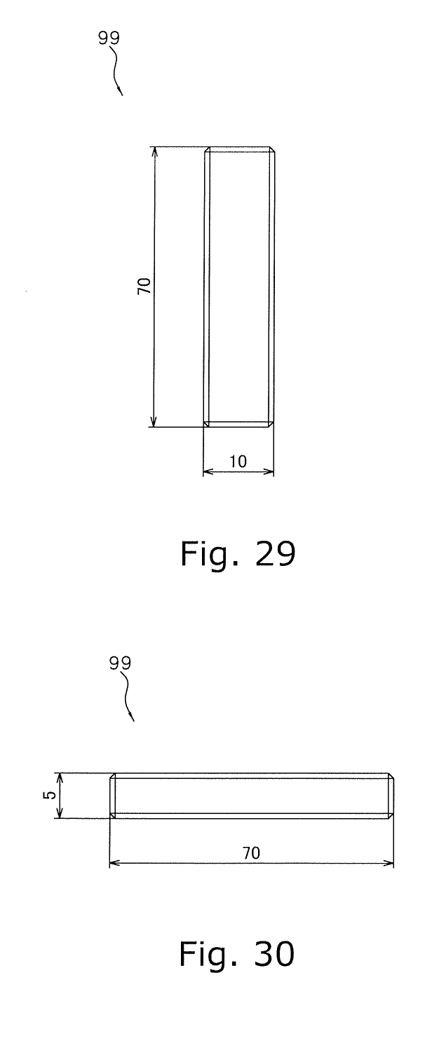

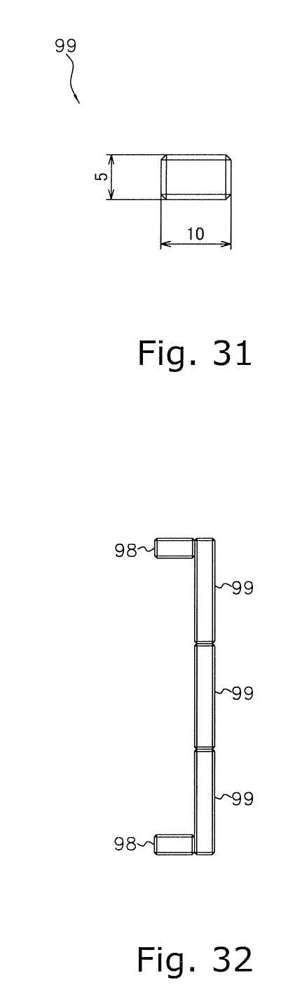

FIG. 29 is a plan view showing the second ferrite 99. FIG. 30 is a view showing one side of the second ferrite 99. FIG. 31 is a view showing another side of the second ferrite 99.

The second ferrite 99 has a substantially rectangular shape, and is composed of a ferrite which is a magnetic material, the same as the first ferrite 98. The details of the second ferrite 99 are the same as those of the first ferrite 98.

As shown in FIGS. 6 and 19, the second ferrites 99 are fixed by bonding in attachment positions on the outside in the radial direction of the bobbin main body 65 in the accommodating spaces in each of the first through fourth ferrite cases 71 through 74 in the electromagnetic induction heating unit 6. The length dimension of each second ferrite 99 in the radial direction is 5 mm when the second ferrites 99 are fixed. The dimension thereof in the direction in which the accumulator tube F extends is 70 mm when the second ferrites 99 are fixed. The dimension of the portion held between the side surfaces 71h is 10 mm when the second ferrites 99 are fixed.

FIG. 32 is a side view showing the state in which the first ferrites 98 and second ferrites 99 are fixed.

Three second ferrites 99 are aligned in the longitudinal direction thereof and positioned so that the end parts thereof in the longitudinal direction are in contact with each other. The first ferrites 98 are arranged so that the longitudinal direction thereof is parallel to the direction of a line normal to the 70 mm×10 mm surfaces of the second ferrites 99. The 10 mm×5 mm surfaces of the first ferrites 98 are arranged in surface contact with the portions of the 70 mm×10 mm surfaces of the second ferrites 99 near each end thereof. An arrangement relationship is more preferably adopted in which the 10 mm×5 mm surfaces of the top end parts of the second ferrites 99 in the longitudinal direction thereof, and the 17 mm×10 mm surfaces of the first ferrites 98 are positioned in substantially the same plane.

In other words, the first ferrites 98 and second ferrites 99 are arranged so that the first ferrite 98 provided at the top of the coil 68 in the direction in which the SUS tube F2 extends, the second ferrites 99 provided in a portion on the outside opposite the inside, the inside being the SUS tube F2 side of the coil 68, and the first ferrite 98 provided at the bottom of the coil 68 are arranged continuously so as to be contact with each other, and a single magnetic body route is thereby formed.

This magnetic body route extends from a position between the coil 68 and the SUS tube F2 at the top of the coil 68 in the direction in which the SUS tube F2 extends, to a position between the coil 68 and the SUS tube F2 at the bottom of the coil 68 in the direction in which the SUS tube F2 extends, via the outside in the radial direction of the coil 68.

<Features of the Air Conditioning Apparatus 1 of the Present Embodiment>

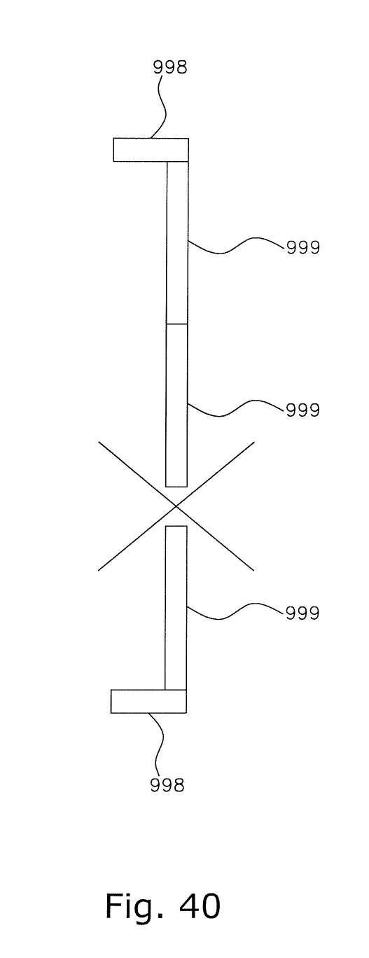

For example, as shown in FIG. 40, when the top ends and bottom ends of second ferrites 999 are held between first ferrites 998, in a case in which there is error in the length of the second ferrites 999 in the longitudinal direction thereof, this error directly affects the distance between the upper and lower first ferrites 998. Therefore, it is sometimes difficult to provide a whole number of second ferrites 999 in contact with each other between the first ferrites 998.

However, in the electromagnetic induction heating unit 6 of the air conditioning apparatus 1 of the above embodiment, the first ferrites 98 are not arranged in the longitudinal direction of the second ferrites 99. Therefore, even when there is some error in the longitudinal dimension of the second ferrites 99, the first ferrites 98 and the second ferrites 99 can be arranged so that the state of contact with each other is maintained without problems. Since some error is allowed, there is no need to use expensive ferrites having high dimensional precision, and cost can be kept low.

The first ferrites 98 and second ferrites 99 are thus arranged continuously so as to be in contact with each other, and a single line for directing magnetic flux is thereby formed. Leakage flux can therefore be efficiently induced to pass through the ferrites.

The first ferrites 98 and second ferrites 99 are also provided in a portion which constitutes a substantially elliptical circumferential portion having the tangential direction of the coil 68 as the axial direction thereof, and magnetic flux can thereby be more efficiently directed.

Furthermore, since the first ferrites 98 and second ferrites 99 include a good conductor material, Joule heat generated by electrical resistance can be minimized. Unwanted heat evolution near the coil 68 can thereby be suppressed, and the temperature of the coil 68 can be kept from increasing. The electrical resistance of the coil 68 as such can thereby be kept from increasing, and magnetic flux can therefore be efficiently generated.

### Other Embodiments

Embodiments of the present invention are described above with reference to the drawings, but the specific configuration is not limited to these embodiments, and can be changed within a range that does not deviate from the scope of the invention.

(A)

An example is described in the embodiment above in which first ferrites 98 and second ferrites 99 are used as two types of ferrite shapes.

However, the present invention is not limited to this configuration.

For example, a configuration may be adopted in which only the first ferrites 98 are arranged so as to touch each other as shown in FIG. 33. In this case, although elements of instability are increased because of the increased number of locations of contact, this configuration can be achieved through the use of ferrites having a single shape, and the cost can therefore be further reduced.

(B)

An example is described in the embodiment above in which two first ferrites 98 and a plurality of second ferrites 99 are used as two types of ferrite shapes.

However, the present invention is not limited to this configuration.

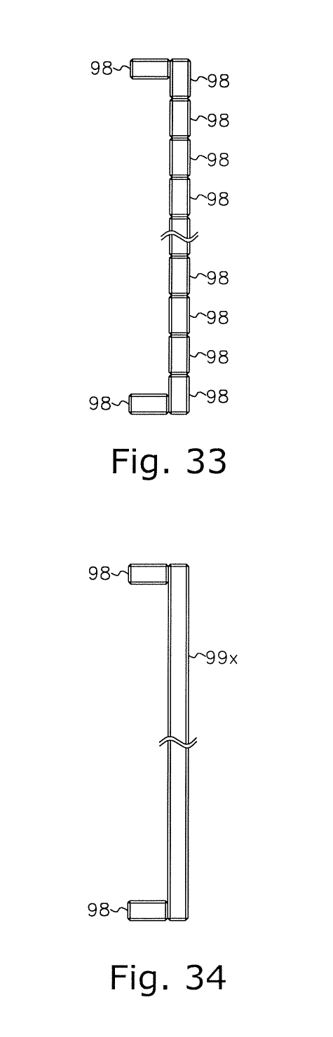

For example, two first ferrites 98 and one second ferrite 99x may be used, as shown in FIG. 34.

In this case, the number of contacting portions can be minimized, and elements of instability are reduced. Leakage flux can therefore be more efficiently reduced.

(C)

In the above embodiment, a case is described in which the electromagnetic induction heating unit 6 is attached to the accumulator tube F in the refrigerant circuit 10.

However, the present invention is not limited to this configuration.

For example, the electromagnetic induction heating unit 6 may be provided to a refrigerant tube other than the accumulator tube F. In this case, the SUS tube F2 or another magnetic body is provided in the portion of the refrigerant tube to which the electromagnetic induction heating unit 6 is provided.

(D)

In the above embodiment, a case is described in which the accumulator tube F is composed of a two-layer tubing structure of copper tubing F1 and SUS tube F2.

However, the present embodiment is not limited to this configuration.

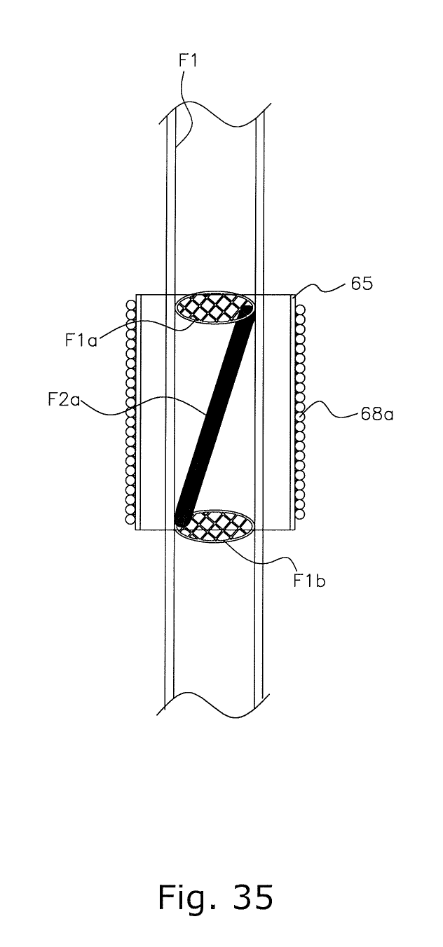

For example, a heated member F2a and two stoppers F1a may be disposed inside the accumulator tube F or a refrigerant tube that is to be heated, as shown in FIG. 35. In this arrangement, the heated member F2a includes a magnetic material, and is a member in which heat is evolved by the electromagnetic induction heating of the embodiment described above. The stoppers F1a in two locations inside the copper tubing F1 constantly allow the refrigerant to pass through, but do not allow the heated member F2a to pass through. The heated member F2a is thereby prevented from moving even when the refrigerant is flowing. It is therefore possible to heat the accumulator tube F or another desired heating position. Since the refrigerant and the heated member F2a in which heat is evolved are also in direct contact, the efficiency of heat transfer can also be enhanced.

(E)

The heated member F2a described in the other embodiment (D) above may also be fixed in position with respect to the tube without the use of the stoppers F1a.

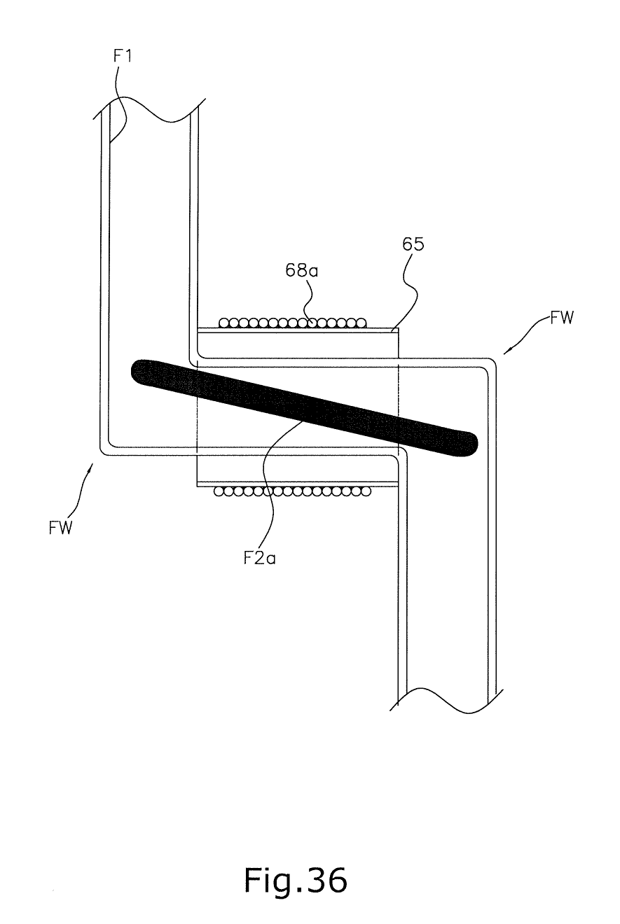

For example, a configuration may be adopted in which bent portions FW are provided in two locations in the copper tubing F1, and the heated member F2a is disposed inside the copper tubing F1 between the two bent portions FW, as shown in FIG. 36. Movement of the heated member F2a can then be suppressed while the refrigerant is allowed to pass through.

(F)

In the above embodiment, a case is described in which the coil 68 is wound in helical fashion around the accumulator tube F.

However, the present invention is not limited to this configuration.

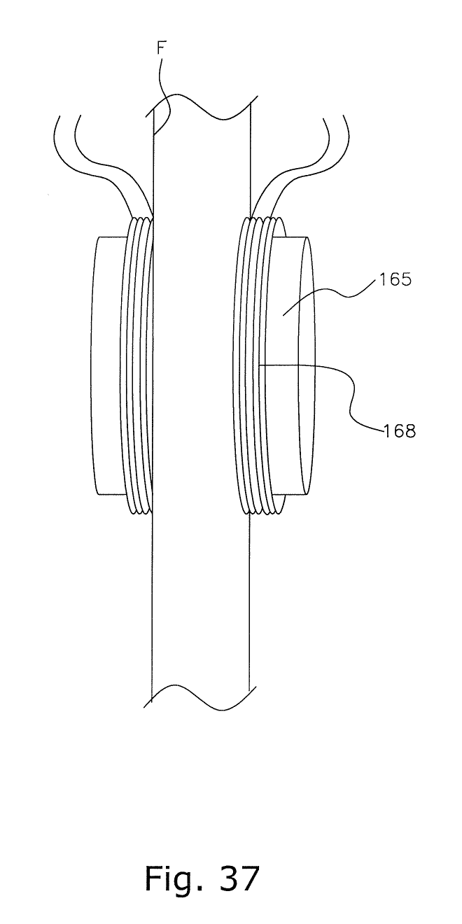

For example, a configuration may be adopted in which a coil 168 wound around a bobbin main body 165 is disposed on the periphery of the accumulator tube F rather than being wound around the accumulator tube F, as shown in FIG. 37. In this arrangement, the bobbin main body 165 is disposed so that the axial direction thereof is substantially perpendicular to the axial direction of the accumulator tube F. The bobbin main body 165 and the coil 168 are also divided into two parts disposed so as to sandwich the accumulator tube F therebetween.

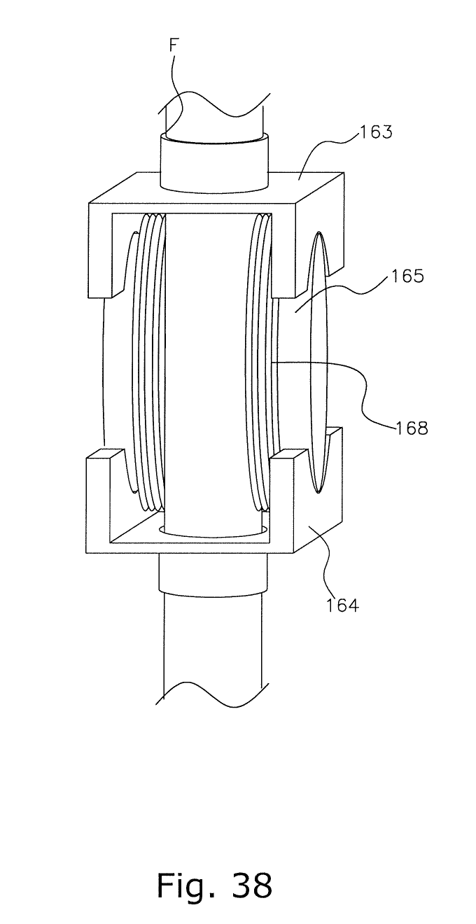

In this case, a first bobbin lid 163 and a second bobbin lid 164 through which the accumulator tube F passes may be disposed so as to fit together with the bobbin main body 165, for example, as shown in FIG. 38.

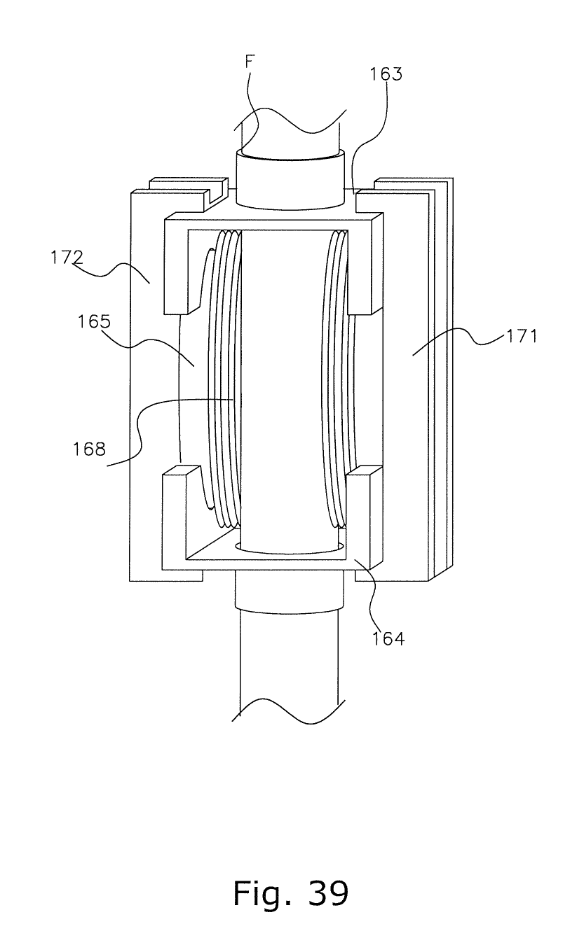

The first bobbin lid 163 and second bobbin lid 164 may also be held fixed by a first ferrite case 171 and a second ferrite case 172 therebetween, as shown in FIG. 39. In FIG. 39, a configuration is shown in which two ferrite cases are disposed so as to hold the accumulator tube F therebetween, but ferrite cases may also be provided in four directions, in the same manner as in the embodiment described above. The ferrites may also be accommodated in the same manner as in the embodiment described above.

### INDUSTRIAL APPLICABILITY

Through the use of the present invention, the effect of the magnetic field on portions other than the refrigerant tube can be minimized even in a case in which a magnetic field is generated by the electromagnetic induction heating unit to perform electromagnetic induction heating. The present invention is therefore useful particularly in an electromagnetic induction heating unit and air conditioning apparatus in which electromagnetic induction is used to heat a refrigerant.

### REFERENCE SIGNS LIST

1 air conditioning apparatus

6 electromagnetic induction heating unit

10 refrigerant circuit (refrigeration cycle)

21 compressor

22 four-way switching valve

23 outdoor heat exchanger

24 motor-driven expansion valve

25 accumulator

41 indoor heat exchanger

61 first hexagonal nut

62 C-ring

63 first bobbin lid

64 second bobbin lid

65 bobbin main body

66 second hexagonal nut

68 coil

71 first ferrite case

72 second ferrite case

73 third ferrite case

74 fourth ferrite case

75 screen cover

98 first ferrite (magnetic body, magnetic body constituent part)

99 second ferrite (magnetic body, magnetic body constituent part)

A discharge tube, refrigerant tube

B indoor-side gas tube, refrigerant tube

C indoor-side liquid tube

D outdoor-side liquid tube

E outdoor-side gas tube, refrigerant tube

F accumulator tube, refrigerant tube

G intake tube, refrigerant tube

H hot-gas bypass circuit

J juncture tubes

### CITATION LIST

### Patent Literature

### <Patent Citation 1>

Japanese Unexamined Patent Application Publication No. 8-210720

1. An electromagnetic induction heating unit configured to heat at least one of a refrigerant tube and a member in thermal contact with a refrigerant that flows through said refrigerant tube, said electromagnetic induction heating unit comprising:
a coil disposed in a vicinity of said refrigerant tube; and
a magnetic member including a magnetic material, said magnetic member being disposed
on at least one of
a first side of said coil along a direction in which said refrigerant tube extends, and
a second side opposite from said first side with respect to said coil along the direction in which said refrigerant tube extends, and
on an outside of said coil that is opposite to an inside of said coil, the inside of said coil being a refrigerant tube side of said coil.

2. The electromagnetic induction heating unit according to claim 1, wherein
said coil is wound around at least a portion of said refrigerant tube.

3. The electromagnetic induction heating unit according to claim 1, wherein
said magnetic member has a plurality of magnetic body constituent parts that are equally sized and shaped.

4. The electromagnetic induction heating unit according to claim 3, further comprising:
at least one magnetic body route in which said magnetic body constituent parts are disposed on
the first one side of said coil along in the direction in which said refrigerant tube extends,
the outside of said coil that is opposite the inside of said coil, and
the second side opposite from the first side with respect to said coil
continuously so as to be adjacent to each other, said magnetic body route extending
from a portion between said refrigerant tube and said coil in a vicinity of an end part on the first side of said coil,
along the direction in which said refrigerant tube extends along the outside of said coil, and
to a portion between said refrigerant tube and said coil in a vicinity of the end part on the second side of said coil.

5. The electromagnetic induction heating unit according to claim 1, wherein
said magnetic member includes a good conductor material.

6. The electromagnetic induction heating unit according to claim 1, wherein
said magnetic member includes a ferrite.

7. An air conditioning apparatus including the electromagnetic induction heating unit according to claim 1, the air conditioning apparatus further comprising
a refrigeration cycle that includes a portion arranged and configured to lead a refrigerant to said refrigerant tube.

8. The electromagnetic induction heating unit according to claim 2, wherein
said magnetic member has a plurality of magnetic body constituent parts that are equally sized and shaped.

9. The electromagnetic induction heating unit according to claim 8, further comprising:
at least one magnetic body route in which said magnetic body constituent parts are disposed on
the first one side of said coil along the direction in which said refrigerant tube extends,
the outside of said coil that is opposite the inside of said coil, and
the second side opposite from the first side with respect to said coil continuously so as to be adjacent to each other,
said magnetic body route extending
from a portion between said refrigerant tube and said coil in a vicinity of an end part on the first side of said coil,
along the direction in which said refrigerant tube extends along the outside of said coil, and
to a portion between said refrigerant tube and said coil in a vicinity of the end part on the second side of said coil.

10. The electromagnetic induction heating unit according to claim 9, wherein
said magnetic member includes a good conductor material.

11. The electromagnetic induction heating unit according to claim 9, wherein
said magnetic member includes a ferrite.

12. The electromagnetic induction heating unit according to claim 2, wherein
said magnetic member includes a good conductor material.

13. The electromagnetic induction heating unit according to claim 2, wherein
said magnetic member includes a ferrite.

14. The electromagnetic induction heating unit according to claim 3, wherein
said magnetic member includes a good conductor material.

15. The electromagnetic induction heating unit according to claim 3, wherein
said magnetic member includes a ferrite.

16. The electromagnetic induction heating unit according to claim 5, wherein
said magnetic member includes a ferrite.
